(19) United States
(12) Patent Application Publication
(10) Pub. No.: US 2016/0045816 A1
(43) Pub. Date: Feb. 18, 2016

(54) COMPRESSED PLAYING CARDS AND GAMES

(71) Applicant: John W. Ogilvie, Salt Lake City, UT (US)

(72) Inventor: John W. Ogilvie, Salt Lake City, UT (US)

(21) Appl. No.: 14/827,302

(22) Filed: Aug. 15, 2015

Related U.S. Application Data
(60) Provisional application No. 62/038,246, filed on Aug. 16, 2014.
(60) Provisional application No. 62/046,583, filed on Sep. 5, 2014.

(51) Int. Cl. A63F 1/02; G09B 19/22; A63F 1/00

(52) U.S. Cl. CPC A63F 1/02; A63F 1/00; G09B 19/22; A63F 2001/005; A63F 2001/006

(57) ABSTRACT

An educational and recreational apparatus includes a deck of cards adapted to form a linear sequence and/or a multi-dimensional tiling. A plurality of individual pips is imprinted on the cards at regularly spaced positions, such as at the corners and/or along the edges of the cards. When the pips are selectively read in an order based on their physical (or depicted virtual) arrangement, e.g., in an aligned order or an order circling a center point of a core, according to a linear sequence or a multi-dimensional tiling, the pips form a pattern. The pattern may be a poker hand, a rummy hand, a rummy set, a sequence of ranks, or another pattern. Use of the apparatus exercises human faculties for search, comparison, and memory, as various possible arrangements of the cards and their pips are explored and evaluated.

### RELATED APPLICATIONS

The present application claims priority to, and incorporates herein by reference the entirety of, U.S. provisional patent application No. 62/038,246 filed 16 Aug. 2014 (“the '246 application”), and U.S. provisional patent application No. 62/046,583 filed 5 Sep. 2014 (“the '583 application”).

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Many card games and other games are played using one or more decks of playing cards. A deck of playing cards is sometimes called a pack or a set. The playing cards in a deck are normally identical to one another in size and shape. The number of cards in the deck is a familiar and expected aspect of the deck. Each playing card has a front side and a back side. Normally the fronts differ but the backs are identical. Thus, players do not know what is on the front of a card if they can only see the back side of the card and if the front of at least one other card in the deck is also unknown. The fronts collectively carry a set of markings, which are individually familiar to the players and also familiar as a complete set. The markings distinguish a given card from at least some of the other cards in the deck and indicate the given card's usage and value under the rules of the game being played. The markings on a given card may be unique, or two or more cards may have the same markings. Even when each card within a complete deck is unique, some duplication may arise by combining two or more complete decks to form a larger deck, which is sometimes called a shoe.

Playing cards may have a printed form. The front side markings and any back side printing can be done on special card stock, thin cardboard, plastic-coated paper, cotton-paper blend, or thin plastic, for example. Playing cards may also have a digital form, in which the front side markings and a back side image or pattern are implemented using digital memory configured with data that represents pixels to be displayed on a screen.

### SUMMARY

Some examples described herein are compressed playing card decks. Such a deck is compressed in comparison with a conventional deck because the compressed deck contains the same complete set of card front-side markings as the conventional deck, but has fewer cards than the conventional deck. An entire compressed deck can be held easily in a player's fingers, making card play possible even when a table or counter is unavailable, because the cards can be held instead of being laid down or placed on a table.

For instance, one compressed deck contains all fifty-two markings found in a conventional poker deck, namely, each of the thirteen ranks (2 through 10, jack, queen, king, and ace) in each of the four suits (clubs, spades, hearts, and diamonds), but this complete set of markings is provided by a compressed deck of nine cards instead of the conventional deck of fifty-two cards. Another compressed deck contains all fifty-two markings found in a conventional poker deck, but has only thirteen cards, each with four of the markings. Different cards in a given compressed deck may bear a different number of markings, but collectively the cards of the compressed deck provide a complete set of the familiar and expected markings, on a smaller-than-usual number of cards. The markings may be assigned to the cards in various ways; some examples are provided herein. Marking assignments make some hands unavailable when playing with a given compressed deck. Marking assignments may alter the relative frequency of hands that are drawn randomly from the compressed deck in comparison to hands drawn randomly from a conventional deck.

During play with a compressed deck, a player may perform moves such as rotating a card about an axis normal to its face to change which markings are in play, and aligning the markings in play to form a particular hand from a collection of possibilities that is supported by the player's current hand. By presenting a larger than normal set of possibilities in a given hand, compressed decks present players with a more challenging search for valuable hands. Card shuffling may include changing not only the relative order of the cards but also their rotational orientation. Markings on the face of a card may be hidden or revealed during play without flipping between the front side and back side of a card. Cards may also be drawn, reordered in one's hand, or discarded. Drawing and discarding may include rotating a card, as well as moving a card between a draw pile, a hand, and/or a discard pile. Solitaire and multiplayer play is described; multiplayer play may be competitive or cooperative.

Some examples herein have physical tiles and/or digital tiles and/or game board squares which bear the markings of one or more compressed decks. Game play may involve placing tiles adjacent one another to make patterns, such as runs of consecutive ranks, groups of the same suit, or poker hands, for example. Some games also permit or require placing tiles partially or entirely atop one another. Cards held in one's hand, dealt from a pile, and/or discarded to a pile may be part of the equipment of some example games. Other equipment, such as meeples and/or other tokens, dice, spinners, score cards, and/or instruction cards may also be part of the equipment of some example games.

The examples given are merely illustrative. This Summary is not intended to identify key features or essential features of the claimed subject matter, nor is it intended to be used to limit the scope of the claimed subject matter. Rather, this Summary is provided to introduce—in a simplified form—some technical concepts that are further described below in the Detailed Description. The innovation is defined with claims, and to the extent this Summary conflicts with the claims, the claims should prevail.

### DESCRIPTION OF THE DRAWINGS

A more particular description will be given with reference to the attached drawings. Drawings and related text pertain to both hand-held flexible cards and to tabletop-laid tiles (which are each considered a kind of “card” in the general sense herein) unless clearly indicated otherwise. These drawings only illustrate selected aspects and thus do not fully determine coverage or scope. In the drawings:

FIG. 1 is a diagram illustrating a hand of playing cards arranged in a configuration referred to herein as a line or a right-on-top line or a right open line;

FIG. 2 is a diagram illustrating a hand of playing cards arranged in a configuration referred to herein as a line or a left-on-top line or a left open line;

FIG. 3 is a diagram illustrating a hand of playing cards arranged in a configuration referred to herein as a stair or a leftward stair or a leftward bottom open stair;

FIG. 4 is a diagram illustrating a hand of playing cards arranged in a configuration referred to herein as a stair or a rightward stair or a rightward bottom open stair;

FIG. 5 is a diagram illustrating a hand of playing cards arranged in a configuration referred to herein as a stair or a leftward stair or a leftward top open stair;

FIG. 6 is a diagram illustrating a hand of playing cards arranged in a configuration referred to herein as a stair or a rightward stair or a rightward top open stair;

FIG. 7 is a diagram illustrating a hand of playing cards arranged in a configuration referred to herein as a ladder or a bottom open ladder;

FIG. 8 is a diagram illustrating a hand of playing cards arranged in a configuration referred to herein as a ladder or a top open ladder;

FIG. 9 is a diagram illustrating a hand of playing cards arranged in a configuration referred to herein as a fan or a left open fan;

FIG. 10 is a diagram illustrating a hand of playing cards arranged in a configuration referred to herein as a fan or a right open fan;

FIG. 11 is a diagram illustrating some conventional suit indicia, a.k.a. suit markers or suits;

FIG. 12 is a diagram illustrating a conventional playing card and the placement of a pip thereon at two locations;

FIG. 13 is a diagram illustrating a deck of playing cards;

FIG. 14 is a diagram illustrating a playing card which is square with rounded corners, as opposed to being a non-square rectangle with rounded corners;

FIG. 15 is a diagram illustrating the conventional usage of one pip per playing card;

FIG. 16 is a diagram illustrating a compressed playing card which has four pip positions represented by P1, P2, P3, and P4;

FIG. 17 is a diagram illustrating a compressed playing card which has six pip positions represented by P1, P2, P3, P4, P5, and P6;

FIG. 18 is a diagram illustrating a compressed playing card which has eight pip positions represented by P1, P2, P3, P4, P5, P6, P7, and P8;

FIG. 19 is a diagram illustrating another compressed playing card with four pip positions;

FIG. 20 is a diagram illustrating another compressed playing card with eight pip positions;

FIG. 21 is a diagram illustrating a compressed deck of playing cards which has seven cards in the deck, eight pips per card, numeric ranks, colored suits, and wildcard pips denoted by stylized faces;

FIG. 22 is a diagram illustrating a compressed deck of playing cards which has seven cards in the deck, eight pips per card, all fifty-two conventional poker deck playing card rank and suit pip symbols, Joker pips denoted by text “JKR”, and wildcard pips denoted by text “BRB” (for “Barbarian”);

FIG. 23 is a diagram illustrating a compressed deck of playing cards which has nine cards in the deck, six pips per card, all fifty-two conventional poker deck playing card rank and suit pip symbols, and Joker pips;

FIG. 24 is a diagram illustrating a hand which includes four of a kind in alignment, namely, four kings, drawn from a compressed deck having nine cards in the deck, six pips per card, all fifty-two conventional poker deck playing card rank and suit pip symbols, and Joker pips;

FIG. 25 is a diagram illustrating a hand which includes compressed cards aligned in a royal flush in the hearts suit, from a compressed playing card deck having nine cards in the deck, six pips per card, all fifty-two conventional poker deck playing card rank and suit pip symbols, and Joker pips;

FIG. 26 is a diagram illustrating a compressed deck of playing cards which has thirteen cards in the deck, four pips per card, and all fifty-two conventional poker deck playing card rank and suit pips in text-only form;

FIG. 27 is a diagram illustrating another compressed deck of playing cards with thirteen cards in the deck, four pips per card, and all fifty-two conventional poker deck playing card rank and suit pips in text-only form;

FIG. 28 is a diagram illustrating a compressed deck of playing cards which has thirteen cards in the deck, four pips per card, and all fifty-two conventional poker deck playing card rank and suit pip symbols, with none of the cards bearing more than one pip of any given rank or more than one pip of any given suit;

FIG. 29 is a diagram illustrating another compressed deck of playing cards with thirteen cards in the deck, four pips per card, and all fifty-two conventional poker deck playing card rank and suit pip symbols, with some cards having more than one pip of a given rank and/or more than one pip of a given suit;

FIG. 30 is a diagram illustrating a compressed deck of playing cards which has fourteen cards in the deck, four pips per card, all fifty-two conventional poker deck playing card rank and suit pips in text-only form, and a joker card;

FIG. 31 is a diagram illustrating another compressed deck of playing cards with fourteen cards in the deck, four pips per card, all fifty-two conventional poker deck playing card rank and suit pips in text-only form, and a joker card;

FIG. 32 is a diagram illustrating another compressed deck of playing cards with fourteen cards in the deck, four pips per card, all fifty-two conventional poker deck playing card rank and suit pip symbols, and a joker card;

FIG. 33 is a diagram illustrating half-rotation of a compressed playing card as a game play mechanism;

FIG. 34 is a diagram illustrating two alternatives for placing rank and suit markings relative to each other on a compressed card's face, with the card face on the left showing a side-by-side placement and the card face on the right showing an over-under placement;

FIG. 35 is a diagram illustrating two alternatives for the back sides of compressed cards, with the card back on the left showing a trademark over a background and the card back on the right showing a formalized pattern;

FIG. 36 is a block diagram illustrating a computer system having at least one processor and at least one memory which interact with one another under the control of software for a game using a compressed deck of cards, and other items in an operating environment which may be present on multiple network nodes, and also illustrating configured storage medium (as opposed to a mere signal) embodiments;

FIG. 37 is a flow chart illustrating steps of some processes for playing with a compressed deck;

FIG. 38 is a flow chart illustrating steps of some processes for specifying, manufacturing, and/or using a compressed deck;

FIG. 39 is a diagram illustrating two overlapping compressed decks, including one with thirteen cards and one with twelve cards, and also illustrating duplicate pips on a given card and duplicate pips on separate cards of a given compressed deck;

FIG. 40 is a diagram illustrating compressed deck game play on a tablet device;

FIG. 41 is a diagram illustrating a compressed playing card which has ten pip positions;

FIG. 42 is a diagram illustrating a straight hand formed with compressed playing cards;

FIG. 43 is a diagram illustrating a full house hand formed with compressed playing cards;

FIG. 44 is a diagram illustrating a hand of compressed playing cards before and after two cards are rotated; and

FIGS. 45 through 47 are diagrams illustrating moves during a tile laying game which uses compressed playing cards as tiles arranged in a two-dimensional tiling.

### REFERENCE NUMERALS

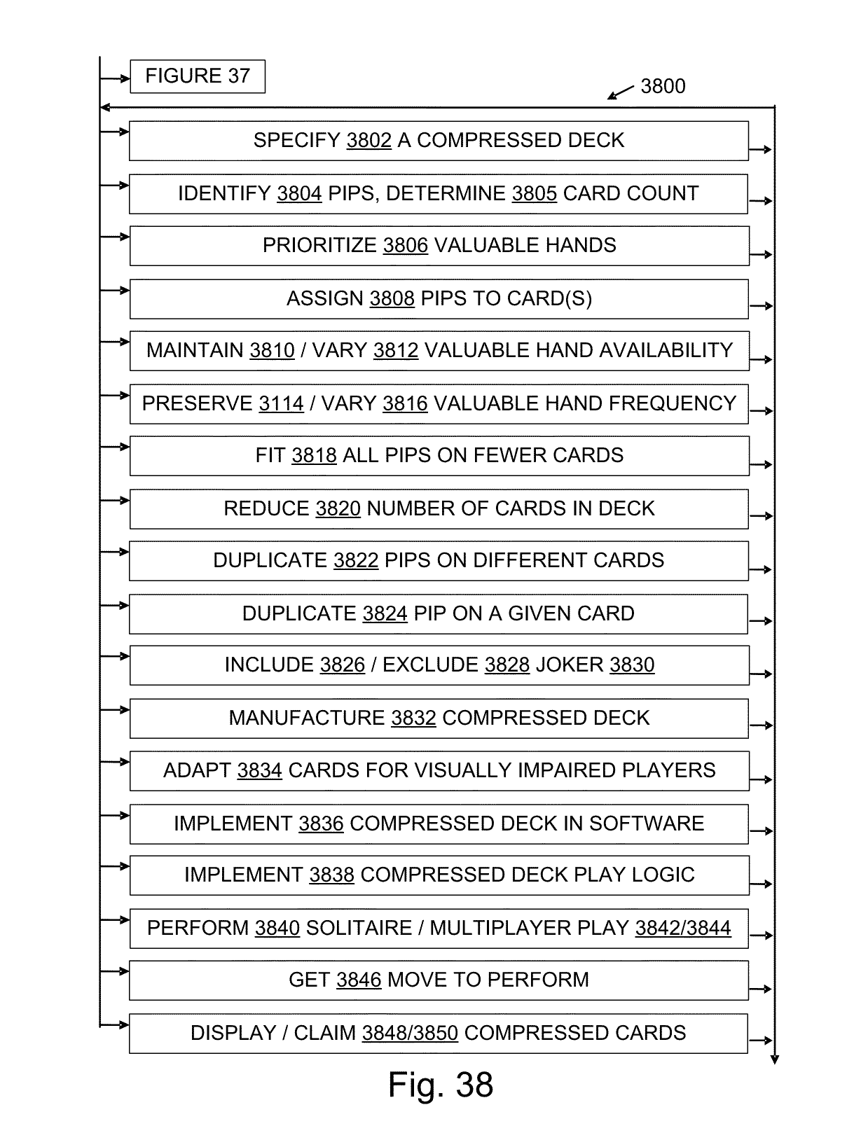

For convenience, a list of reference numerals used in the figures for items (but not those used for steps) is provided below:
102 playing card(s) (conventional or new)
104 a hand of playing cards
106 an arrangement of playing cards
1102 conventional suits: red diamond (D), black spade (S), red heart (H), black club (C), and/or other suit indicators such as other symbols, names, and/or colors
1202 shorter side of playing card
1204 longer side of playing card
1206 pip (conventional or new), a.k.a. marking or symbol
1208 conventional ranks: A (ace), 2, 3, 4, 5, 6, 7, 8, 9, J (jack), Q (queen), K (king)
1302 deck of playing cards (conventional or new)
2402 valuable hand, namely a hand which has a score and/or has greater value than other possible hands and/or is a goal during game play
3602 device (smartphone, tablet, laptop, etc.) or computer (workstation, server, device, etc.)
3402 front of a compressed card
3502 back of a compressed card
3604 user, e.g., player
3606 peripherals, e.g., disk, printer, etc.
3608 networks, e.g., LAN, WAN, etc.
3610 processors, e.g., CPU, GPU, etc.
3612 memory/media, e.g., RAM, ROM, flash, disk, etc.
3614 configured medium, e.g., 3612 with instructions 3616 and data 3618
3620 game software, e.g., for poker, valuable hand search, solitaire, etc.
3622 game's graphical user interface
3624 digital form of compressed deck 3710, e.g., ordered list of card objects each with pip fields plus in-play-pips list plus face-up/face-down indicator
3626 digital move logic, e.g., to implement steps in FIG. 37
3628 digital information sharing logic, e.g., to support networked play by sharing game state (e.g., game identifier and version, player names, whose turn it is, current deck 3624, and player scores) with another device 3602
3630 display, e.g., tablet or laptop or smartphone screen
3632 other I/O hardware, e.g., speakers, keyboards
3706 game generally, whether played with printed cards or with a device 3602
3710 compressed deck generally, whether in printed or digital form
3712 rules for playing with compressed deck, e.g., what moves 3720 can be made, any limits on the number of moves, which hands 104 are valuable hands 2402, turn order, how hands are scored, and how game ends
3744 table, countertop, or other surface one might use in playing a game
3830 Joker card
4002 tablet device
4004 game software controls, menus, links to other information
4006 text displayed by game software, e.g., instructions, scores, player names
4602 core (a.k.a. junction) where certain tiles meet
4604 meeple or some other token
Pi Pip position i, e.g., P1, P2, P3, P3 denote positions of instances of four respective pips on a playing card
Pi:Ci Pip and color at position i, e.g., P3:blue means a blue pip at position P3

### DETAILED DESCRIPTION

Acronyms

Some acronyms are defined below, but others may be defined elsewhere herein or require no definition to be understood by one of skill.

ALU: arithmetic and logic unit

CD: compact disc

CPU: central processing unit

DVD: digital versatile disk or digital video disc

FPGA: field-programmable gate array

FPU: floating point processing unit

GPU: graphical processing unit

GUI: graphical user interface

I/O: input/output

LAN: local area network

RAM: random access memory

ROM: read only memory

WAN: wide area network

Overview

Some embodiments described herein may be viewed in a broader context. For instance, concepts such as chance, players, skill, turns, and winning may be relevant to a particular embodiment. However, it does not follow from the availability of a broad context that exclusive rights are being sought herein for abstract ideas; they are not. Rather, the present disclosure is focused on providing appropriately specific embodiments whose technical effects fully or partially solve particular technical problems. Other media, systems, and processes involving chance, players, skill, turns, and/or winning are outside the present scope. Accordingly, vagueness, mere abstractness, lack of technical character, and accompanying proof problems are also avoided under a proper understanding of the present disclosure.

The technical character of embodiments described herein will be apparent to one of ordinary skill in the art, and will also be apparent in several ways to a wide range of attentive readers. First, some embodiments address technical problems such as providing novel playing cards which can be easily used while standing in line, riding a metro, or in other situations where table or counter space is scare or unavailable, while retaining familiar aspects of conventional playing cards. Second, some embodiments include technical components such as computing hardware which interacts with software in a manner beyond the typical interactions within a general purpose computer. For example, in addition to normal interaction such as memory allocation in general, memory reads and write in general, instruction execution in general, and some sort of I/O, some embodiments described herein alter the normal and expected play of original games according to rules and mechanisms described herein. Third, technical effects provided by some embodiments inject changes in fortune into the play of an original game, e.g., by changing the relative frequencies of available poker hands and/or changing the mechanisms which manipulate cards to alter a hand. Fourth, some embodiments include technical adaptations such as playing cards bearing multiple different pips per card, decks intended for play rather than card tricks that have different numbers of pips than cards of a familiar deck, decks having all conventional pips but fewer than fifty-two cards (or fewer than another traditional deck's number of cards), and/or card rotation and card pip alignment as play mechanisms.

Terminology Generally

Reference is made to exemplary embodiments, and specific language will be used herein to describe the same. But alterations and further modifications of the features illustrated herein, and additional technical applications of the abstract principles illustrated by particular embodiments herein, which would occur to one skilled in the relevant art(s) and having possession of this disclosure, should be considered within the scope of the claims.

The meaning of terms is clarified in this disclosure, so the claims should be read with careful attention to these clarifications. Specific examples are given, but those of skill in the relevant art(s) will understand that other examples may also fall within the meaning of the terms used, and within the scope of one or more claims. Terms do not necessarily have the same meaning here that they have in general usage (particularly in non-technical usage), or in the usage of a particular industry, or in a particular dictionary or set of dictionaries. Reference numerals may be used with various phrasings, to help show the breadth of a term. Omission of a reference numeral from a given piece of text does not necessarily mean that the content of a Figure is not being discussed by the text.

The inventor asserts and exercises his right to his own lexicography. Quoted terms are defined explicitly, but quotation marks are not used when a term is defined implicitly. Terms may be defined, either explicitly or implicitly, here in the Detailed Description and/or elsewhere in the application file.

“Card” as used herein includes items whose substrate is card stock, a die, or a tile, either physically or digitally implemented. Many of the examples herein emphasize cards printed on card stock, but extensions or adaptations to other substrates will be apparent to one of skill in the art from the teachings herein, such as teachings about pip selection and placement, shuffling and rotating, and hand formation, for example.

Decks are sometimes also called “packs” or “sets”. A deck includes a set of cards whose pips are printed, embossed, molded, burned, engraved, rendered, or otherwise placed on at least one kind of card substrate. As used herein a deck printed on card stock, for example, is more than merely a collection of playing cards, because a deck contains a complete set of pips. For instance, a conventional poker deck includes fifty-two pips, of four suits and thirteen ranks. A collection of poker cards containing only hearts does not qualify as a “deck” in the sense meant herein because the pips for diamonds, clubs, and spades are missing. Likewise, a collection containing only face cards is not a “deck” in the sense meant herein because the pips for aces and for ranks 2 through 10 are missing.

In some examples, a “compressed deck” is a deck of cards which are sold or otherwise commercially provided as a unit, and which has fewer cards than a conventional deck that contains the same complete set of pips as the compressed deck. Thus, merely removing cards from a conventional deck does not produce a compressed deck, because the pips on the removed cards will be missing. Likewise, removing cards from a conventional deck and inserting a smaller number of gaff cards does not produce a compressed deck, because the conventional deck is sold or otherwise commercially provided separately from the gaff cards, e.g., the gaff cards are sold individually or sold as part of a gaff pack.

In some examples, gaff packs are further distinguished from compressed decks in that the gaff packs contain pips which are not part of the conventional set of pips and are not used in a compressed deck, e.g., a 3½ of clubs pip or a 13 of diamonds pip. Gaff cards may also contain blank spaces where a normal card (or a compressed card) has printed matter and/or gaff cards may have pips printed on the back side of the card, e.g., one gaff card is blank on one side, and on the back side it has a 6 of spades printed on top of the normal back side pattern. Use of such a gaff card in a software game of cards would be considered either a malfunction or a cheat.

In some examples, gaff packs are further distinguished from compressed decks in that gaff packs are configured and intended for tricks, not for game play. As a result, the pip layout (pip positioning on the card) varies widely from one gaff card to another in a gaff pack, according to the needs of the particular card trick for which the gaff card in question is designed. By contrast, compressed decks use a single pip layout, or in some examples use two or at most three pip layouts. The uniformity in compressed card pip layout thus sets the compressed deck apart from a gaff deck. Various pip layouts are illustrated in FIGS. 16-34 and 39-41.

A “pip” is a marking used on the front of a card in a conventional deck to distinguish the card from other cards in the deck. In discussions outside the present disclosure, “pip” is sometimes used to mean “suit marking” and the rank is not considered part of the pip. But in the present disclosure a “pip” in a compressed deck includes both suit and rank when the compressed deck uses both suits and ranks as markings. If cards in a deck are distinguished only by number, then the pips are numbers. If cards are distinguished by different combinations of numbers and colors, then the pips are those different combinations of numbers and colors. Cards for visually impaired persons may have Braille or other tactile pips. Pips may also be vocal, e.g., they may take the form of recorded or synthesized speech reciting phrases such as “Ace of Spades” or “Queen of Hearts” or “Green 7” or “Klingon Ace”.

As used herein, “include” allows additional elements (i.e., includes means comprises) unless otherwise stated. “Consists of” means consists essentially of, or consists entirely of. X consists essentially of Y when the non-Y part of X, if any, can be freely altered, removed, and/or added without altering the functionality of claimed embodiments so far as a claim in question is concerned.

Throughout this document, use of the optional plural “(s)”, “(es)”, or “(ies)” means that one or more of the indicated feature is present. For example, “card(s)” means “one or more cards” or equivalently “at least one card”.

References to holding a deck or some cards in one's fingers might also be stated as holding a deck or some cards in one's hand, but doing so would give the word “hand” two different and potentially confused meanings: a “hand” would be a body part which generally has four fingers and a thumb (some people's hands have fewer fingers, for instance), and a “hand” would also be a subset of the cards in a deck. So references herein are to holding a deck or some cards in one's fingers, and the word “hand” refers to cards, not to a body part.

Some Digital Terminology

Some but not all embodiments describe herein are computerized. As used herein, a “computer system” may include, for example, one or more servers, motherboards, processing nodes, personal computers (portable or not), personal digital assistants, smartphones, cell or mobile phones, other mobile devices having at least a processor and a memory, and/or other device(s) providing one or more processors controlled at least in part by instructions. The instructions may be in the form of firmware or other software in memory and/or specialized circuitry. In particular, although it may occur that many embodiments run on tablets or smartphones, other embodiments may run on other computing devices, and any one or more such devices may be part of a given embodiment.

A “logical processor” or “processor” is a single independent hardware thread-processing unit, such as a core in a simultaneous multithreading implementation. As another example, a hyperthreaded quad core chip running two threads per core has eight logical processors. A logical processor includes hardware. The term “logical” is used to prevent a mistaken conclusion that a given chip has at most one processor; “logical processor” and “processor” are used interchangeably herein. Processors may be general purpose, or they may be tailored for specific uses such as graphics processing, signal processing, floating-point arithmetic processing, encryption, I/O processing, and so on.

A “multiprocessor” computer system is a computer system which has multiple logical processors. Multiprocessor environments occur in various configurations. In a given configuration, all of the processors may be functionally equal, whereas in another configuration some processors may differ from other processors by virtue of having different hardware capabilities, different software assignments, or both. Depending on the configuration, processors may be tightly coupled to each other on a single bus, or they may be loosely coupled. In some configurations the processors share a central memory, in some they each have their own local memory, and in some configurations both shared and local memories are present.

“Kernels” include operating systems, hypervisors, virtual machines, BIOS code, and similar hardware interface software.

“Code” means processor instructions, data (which includes constants, variables, and data structures), or both instructions and data.

“Program” is used broadly herein, to include applications, kernels, drivers, interrupt handlers, libraries, and other code written by programmers (who are also referred to as developers).

“Process” is sometimes used herein as a term of the computing science arts, and in that technical sense encompasses resource users, namely, coroutines, threads, tasks, interrupt handlers, application processes, kernel processes, procedures, and object methods, for example. “Process” is also used herein as a patent law term of art, e.g., in describing a process claim as opposed to a system claim or an article of manufacture (configured storage medium) claim. Those of skill will understand which meaning is intended in a particular instance, and will also understand that a given claimed patent process may sometimes be implemented using one or more computing processes.

“Computationally” likewise means a computing device (processor plus memory, at least) is being used, and excludes obtaining a result by mere human thought or mere human action alone. For example, doing arithmetic with a paper and pencil is not doing arithmetic computationally as understood herein. Computational results are faster, broader, deeper, more accurate, more consistent, more comprehensive, and/or otherwise provide technical effects that are beyond the scope of human performance alone. “Computational steps” are steps performed computationally.

“Proactively” means without a direct request from a user. Indeed, a user may not even realize that a proactive step by an embodiment was possible until a result of the step has been presented to the user. Except as otherwise stated, any computational and/or automatic step described herein may also be done proactively.

Throughout this document, unless expressly stated otherwise any reference to a step in a process presumes that the step may be performed directly by a party of interest and/or performed indirectly by the party through intervening mechanisms and/or intervening entities, and still lie within the scope of the step. That is, direct performance of the step by the party of interest is not required unless direct performance is an expressly stated requirement.

Whenever reference is made to data or instructions, it is understood that these items configure a computer-readable memory and/or computer-readable storage medium, thereby transforming it to a particular article, as opposed to simply existing on paper, in a person's mind, or as a mere signal being propagated on a wire, for example. For the purposes of patent protection in the United States, no claim covers a signal per se, and a memory or other computer-readable storage medium is not a propagating signal or a carrier wave outside the scope of patentable subject matter under United States Patent and Trademark Office (USPTO) interpretation of the In re Nuijten case.

Moreover, notwithstanding anything apparently to the contrary elsewhere herein, a clear distinction is to be understood between (a) computer readable storage media and computer readable memory, on the one hand, and (b) transmission media, also referred to as signal media, on the other hand. A transmission medium is a propagating signal or a carrier wave computer readable medium. By contrast, computer readable storage media and computer readable memory are not propagating signal or carrier wave computer readable media. Thus, “computer readable medium” means a computer readable storage medium, not a propagating signal per se.

For the purposes of patent protection in the United States, at least, patentable subject matter which is described and disclosed herein includes subject matter to be claimed as defined in the In re Gulack case. For example, some embodiments include an educational and recreational apparatus (which is, by the way, a manufacture per 35 United States Code §101) including a deck of cards and/or other tiles adapted to form a linear sequence and/or a multi-dimensional tiling and a plurality of individual pips imprinted on the cards and/or other tiles at regularly spaced positions, the pips when selectively read in order according to the linear sequence or multi-dimensional tiling constituting a pattern which includes at least one of the following: a poker hand, a rummy hand, a rummy set, an arithmetic sequence of ranks.

Other variations are also apparent from the teachings herein, e.g., variations in the shape of the tiles of a given deck, in the number of pips per tile, in the number of tile rotations permitted after a tile has been laid on the table, in the number of tiles within a deck of tiles that has at least one graphical or textual instance of each of the fifty-two conventional pips of a poker deck, in the extent to which a deck of tiles departs from a conventional poker deck in the relative frequency of valuable hands, and in the extent to which a deck of tiles departs from a conventional poker deck in the number of possible valuable hands.

Additional details and design considerations are provided below. As to all the examples herein, the features described may be used individually and/or in combination, or not at all, in a given embodiment.

Card Arrangements

Many if not all conventional decks have too many cards to easily hold them all simultaneously in one's fingers, especially if one is also trying to hold a fan or other arrangement of several cards that have been drawn. People who do not have many hours of practice manipulating a standard deck of 52 cards, for example, tend to drop cards or have difficulty reading card markings, or get sore muscles, if they attempt to hold all 52 cards in their fingers for more than a few minutes. This is not true of compressed decks, because they contain only a fraction as many cards. The availability of a compressed deck can thus move attention away from traditional card play configurations centered on a table, to situations in which a deck is held completely in one's fingers.

The ability to hold all the cards of a compressed deck in the fingers of one or more players makes it possible to enjoy card games without tables or similar surfaces, e.g., when one is standing in line, or in a room without available counter space. When the ability to hold all cards in one's fingers is combined with multi-pip cards as taught herein, players also have a new set of meaningful card arrangements.

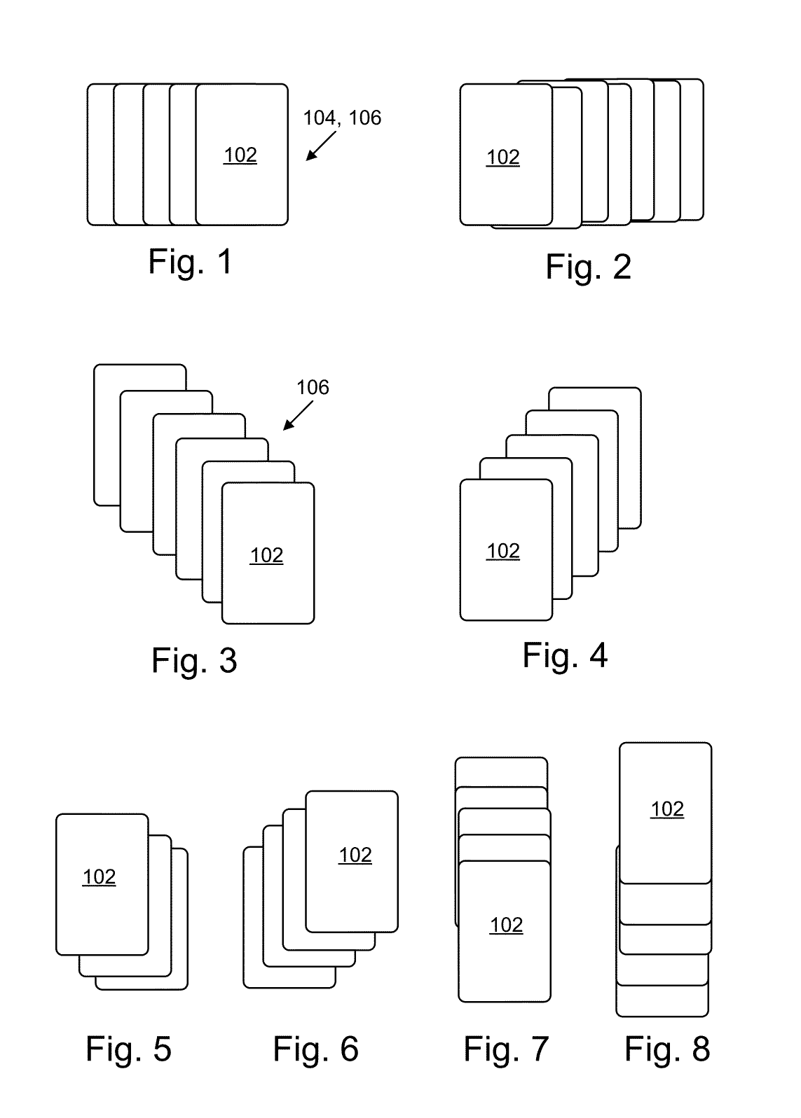

FIGS. 1-10 illustrate different ways to arrange a hand 104 of cards 102 held in a player's fingers (not shown). The FIG. 1-10 arrangements 106 take on particular meaning when viewed in conjunction with the pip-position examples shown in FIGS. 16-20 and 41. For example, different arrangements reveal different combinations of pips from which a player may try to build hands. Different card arrangements 106 correspond to different sets of visible pips and/or different sets of pips available (a.k.a., “in play”) to use in making a valuable hand. By contrast, in a hand of a standard conventional poker deck the visible pips and the available pips do not vary according to the arrangement, and the arrangement to use during play does not vary depending on the pips desired. The pips visible are the same (one per card) no matter how the cards are held in one's fingers. Likewise, the pips available are the same (one per card) no matter how the cards are held in one's fingers. Switching between an arrangement like FIG. 1 and an arrangement like FIG. 7, for example, would not change the pips available in a hand of a conventional poker deck.

In some examples, pip positions vary according to the compressed deck and/or compressed card being used. In the card arrangement illustrated by FIG. 1, all the left edge pips are visible; these correspond, e.g., to pip positions P1 and P4 of FIG. 16, P1 and P6 of FIG. 17, P1 and P6 and P8 of FIG. 18, P1 of FIG. 19, P1 and P2 and P3 and P4 of FIG. 20, and P1 and P8 and P9 and P10 of FIG. 41. In a more concise notation, this information is represented as {Figure #: Pip Position(s)} groups as follows: {16: P1, P4}, {17: P1, P6}, {18: P1, P6, P8}, {19: P1}, {20: P1, P2, P3, P4}, {41: P1, P8, P9, P10}. FIG. 2 shows an arrangement in which right edge pips are visible, corresponding to {16: P2, P3}, {17: P3, P4}, {18: P3, P4, P7}, {19: P4}, {20: P5, P6, P7, P8}, {41: P3, P4, P5, P6}. FIGS. 7 and 8 show similar arrangements, except the visible pip positions are along the top of the cards or the bottom of the cards, respectively.

FIGS. 3, 4, 5, and 6 show arrangements 106 in which pip positions along two card edges are visible. At the risk of belaboring points already understood, FIG. 3 corresponds for example to visible pips as follows: {16: P1, P2, P4}, {17: P1, P2, P3, P6}, {18: P1, P2, P3, P6, P8}, {19: P1, P2, P3, P4}, {20: P1, P2, P3, P4, P5}, {41: P1, P2, P3, P8, P9, P10}.

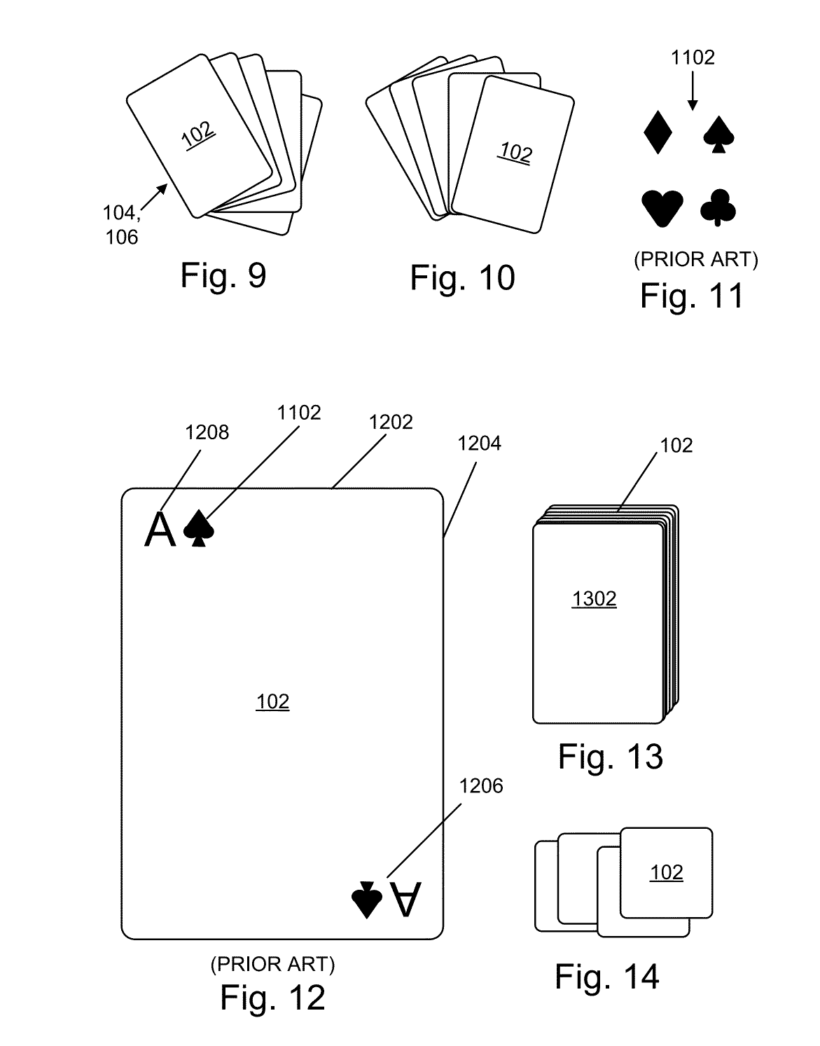

FIGS. 9 and 10 show fan arrangements 106. These arrangements are suitable for games in which the top right corner pip (FIG. 9) or the top left corner pip (FIG. 10) are available to use in forming a hand.

Note that in some games, even though pips are visible they are not necessarily available for use in making a desired hand. A move such as a card rotation or a card alignment may be needed, e.g., when only top edge pips are available but a bottom edge pip is visible. In some games only one set of visible pips is elected by the player and thus available. Election is a kind of alignment. The election may be done before any pips are revealed. For instance, a player may elect to try and make the best possible hand 104 using only the top right corner pips, in which case the arrangement of FIG. 4 or the arrangement of FIG. 9 would be used, and the available pips (a subset of the visible ones) for a given hand of cards are those in the following positions: {16: P2}, {17: P3}, {18: P3}, {19: P4}, {20: P5}, {41: P3}.

Combining Pips on Cards

FIG. 11 shows conventional suit indicia 1102, also known as suit markers or suits. From top left clockwise these are diamond, spade, club, and heart. Embodiments are not limited to use of these particular suits, or to their use in the most common colors (black for spades and clubs, red for hearts and diamonds). Nor are the embodiments limited to precisely four suits.

FIG. 12 shows a conventional playing card and the placement of a pip thereon. This card 102 has two shorter sides or edges 1202 and two longer sides or edges 1204; other cards take different shapes. The pip 1206 includes a suit 1102 and a rank 1208. The illustrated suit 1102 is spades and the illustrated rank 1208 is Ace. FIG. 12 also illustrates the conventional usage of one pip per playing card. In this example, the pip 1206 is placed at two locations—top left corner and bottom right corner of the card—but it is only one of the 52 pips in a conventional poker deck.

FIG. 13 shows a deck 1302 of playing cards 102. Like many conventional cards, the cards in this deck are generally rectangular, with rounded edges. However, cards 102 may also have other shapes. For instance, FIG. 14 shows playing cards 102 which are square with rounded corners, as opposed to being a non-square rectangle with rounded corners as in FIG. 13. Other card 102 shapes are also contemplated, e.g., circles, ovoids, octagons, septagons, hexagons, pentagons, triangles, as well as the various shapes used for conventional cards.

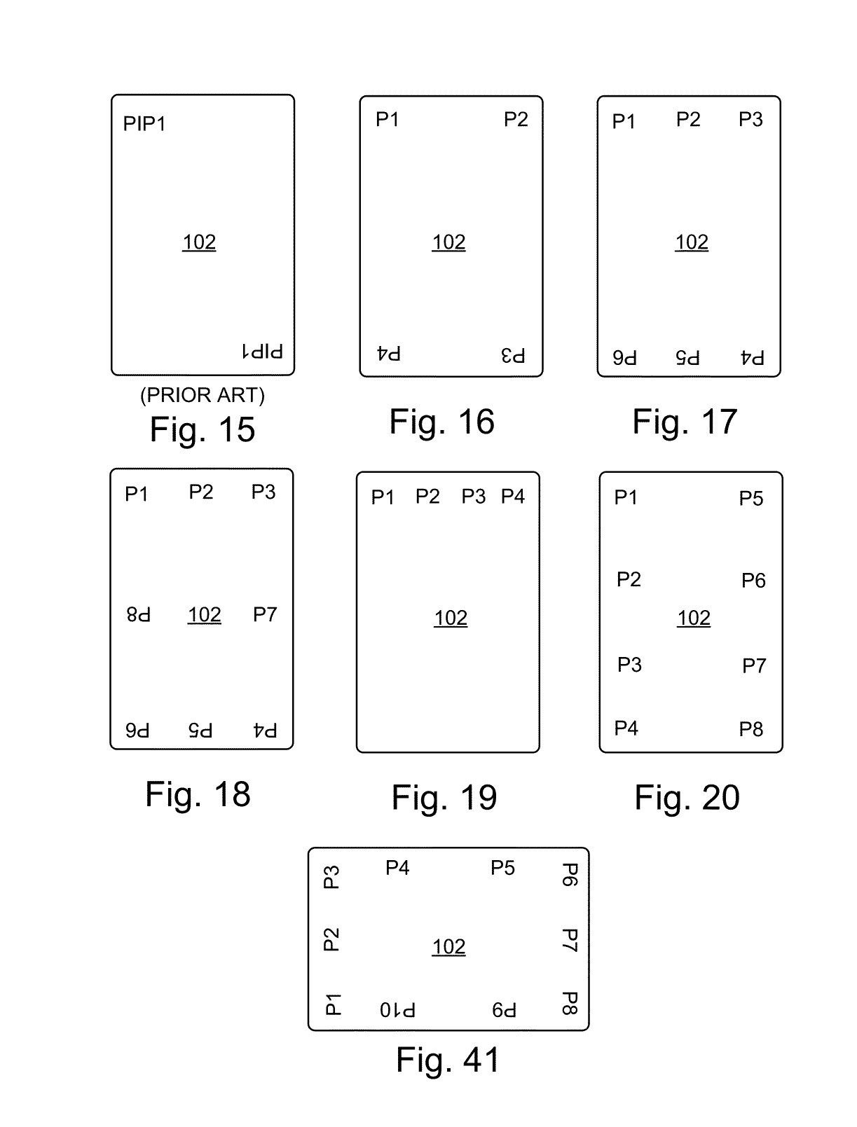

FIG. 15 shows a conventional usage of one pip per playing card, with the single pip being represented by PIP1 in this diagram. In contrasting layouts, FIG. 16 shows a compressed playing card which has up to four different pips at layout positions represented by P1, P2, P3, and P4. All four layout positions are occupied. FIG. 17 shows a compressed playing card which has up to six different pips occupying layout positions represented by P1, P2, P3, P4, P5, and P6. FIG. 18 shows a compressed playing card which has up to eight different pips occupying layout positions represented by P1, P2, P3, P4, P5, P6, P7, and P8. FIG. 19 shows another compressed playing card with four layout positions. Other layout configurations having pips only along one edge of a card are also contemplated, e.g., with two pips, or with three pips, along one edge 1202 or 1204 and no pips along at least one of the other edges. FIG. 20 shows another compressed playing card with eight pip layout positions. FIG. 41 shows a compressed playing card which has up to ten different pips occupying the designated layout positions P1 through P10. Although not shown, other innovative configurations are also contemplated herein, including an odd number (e.g., 3, 5, 7, 9) of pips per card 102. One layout for a two-pip card has pips at positions P1 and P2 along one short edge and the same pips at corresponding positions P1′ and P2′ along the other short edge. Layouts which have multiple pips along a single edge permit pip alignment to be part of valuable hand formation. A circular card 102 has only one edge, so pip alignment also involves card rotation in that case. Likewise, when playing with polygonal compressed cards that have N sides, rotations by 1/Nth of a full 360 degrees (two pi) or by an integer multiple of that amount are possible, as well as rotations by 1/Pth of a full 360 degrees (two pi), where P is the number of pip positions on the card. For instance, in some embodiments of a 4-sided card with 8 pip positions per card, rotations by multiples of 90 degrees (2π/4) are permitted, and in some of these embodiments card rotations by multiples of 45 degrees (2π/8) are also permitted. FIG. 33 illustrates half-rotation of a compressed playing card as a game play mechanism. In some embodiments, only the upright pips are in play, namely, available for use in forming valuable hands 2402.

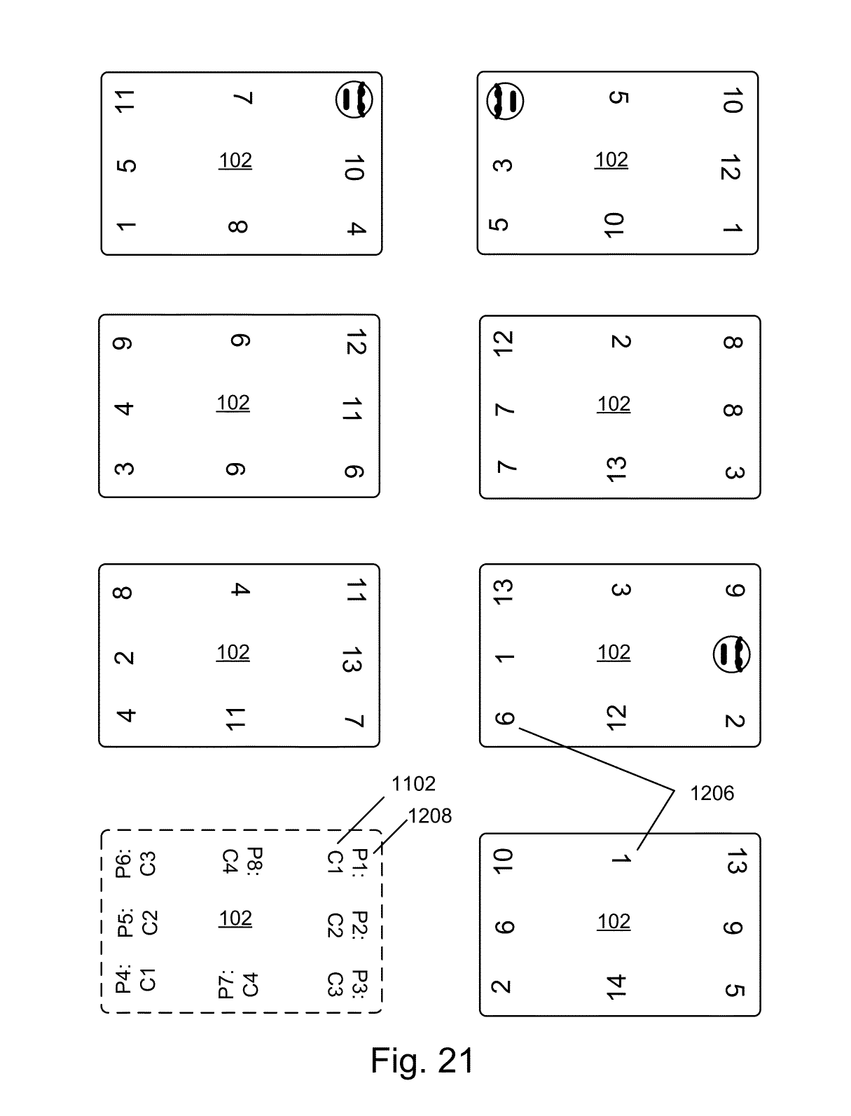

FIG. 21 illustrates a compressed deck of playing cards which has seven cards in the deck, eight pips per card, numeric ranks, colored suits, and wildcard pips denoted by stylized faces and herein abbreviated as W. In one particular such deck, the colors and their respective abbreviations here are orange: O, dark green: D, pink: P, light green: L. Beginning with the top left card and moving through the pips in order and then the cards in order from left to right and top to bottom, the color assignments in one example are WO (wildcard orange), 10D (10 dark green), 4P (4 pink), 1O, 5D, 11P, 8L, 7L; next card 10O, 12D, 1P, 5O, 3D, WP, 10L, 5L; next card 12O, 11D, 6P, 3O, 4D, 9P, 9L, 6L; next card 8O, 8D, 3P, 7O, 7D, 12P, 13L, 2L; next card 11O, 13D, 7P, 4O, 2D, 8P, 11L, 4L; next card 9O, WD, 2P, 6O, 1D, 13P, 12L, 3L; and final card 13O, 9D, 5P, 2O, 6D, 10P, 14L, 1L. Many variations in color choice, color count, pip count, card count, individual pip count, and pip orientation on the card are also possible.

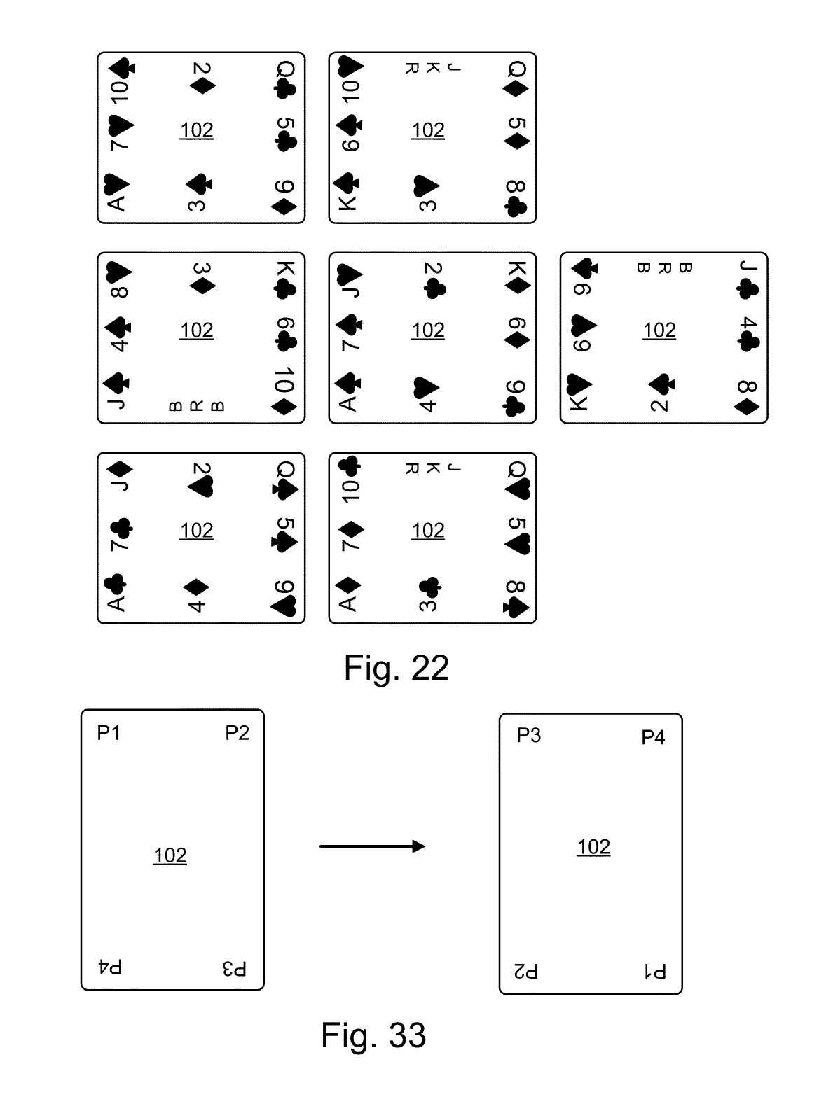

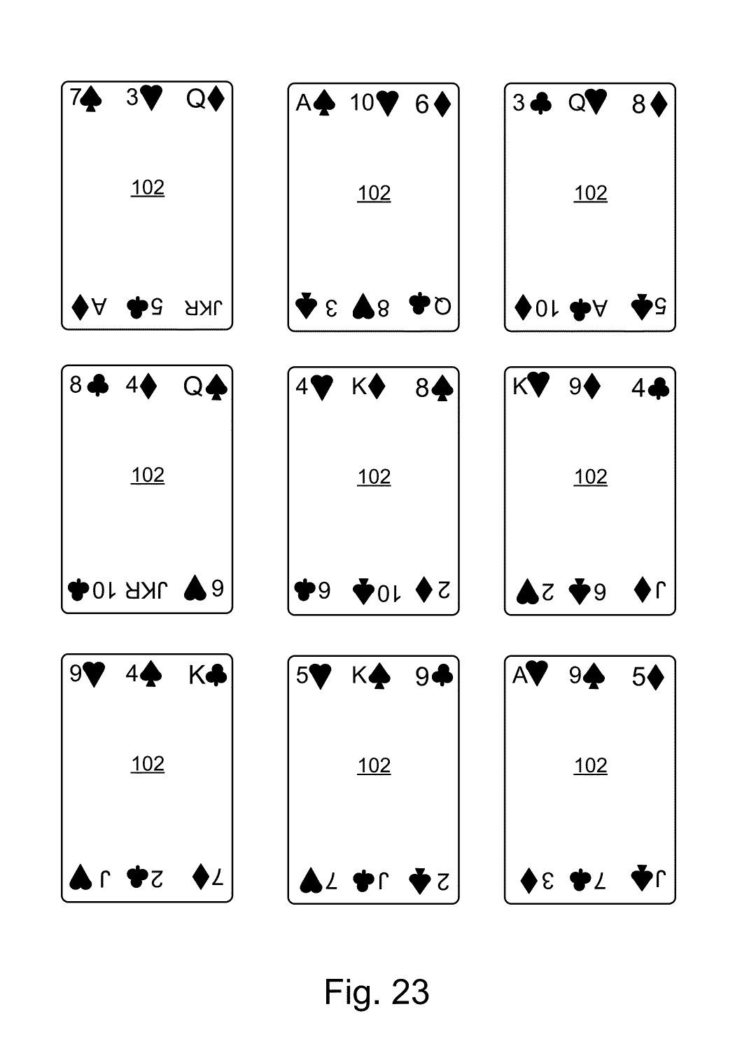

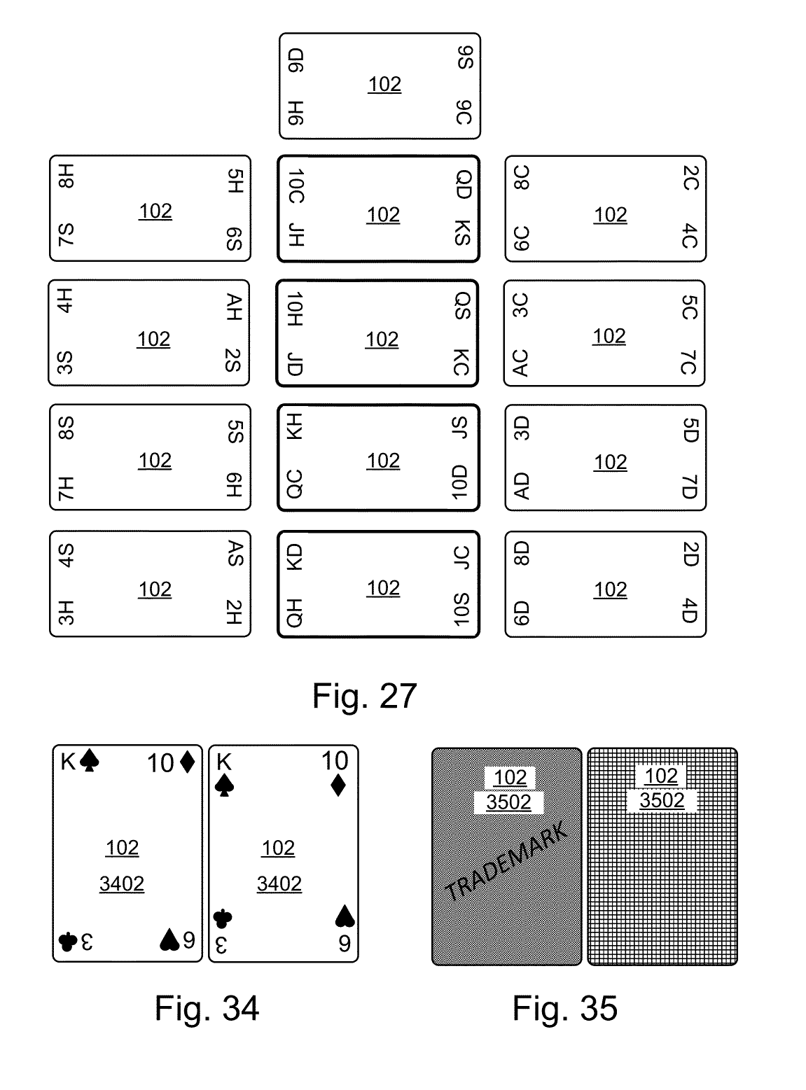

FIG. 22 illustrates a compressed deck of playing cards which has seven cards in the deck, eight pips per card, all fifty-two conventional poker deck playing card rank and suit pip symbols, Joker pips denoted by text “JKR”, and wildcard pips denoted by text “BRB” (for “Barbarian”). As in a conventional deck, each Joker has a color (typically red or black), whereas Barbarians do not. That is, Barbarians may be shown as both red and black so they match either color, or as some other color, e.g., green, again to indicate that they match suits of either color. To help further illustrate possible forms, the cards in FIG. 22 are relatively square, in comparison for instance to the cards in FIG. 21 or those in FIG. 23 or FIG. 27.

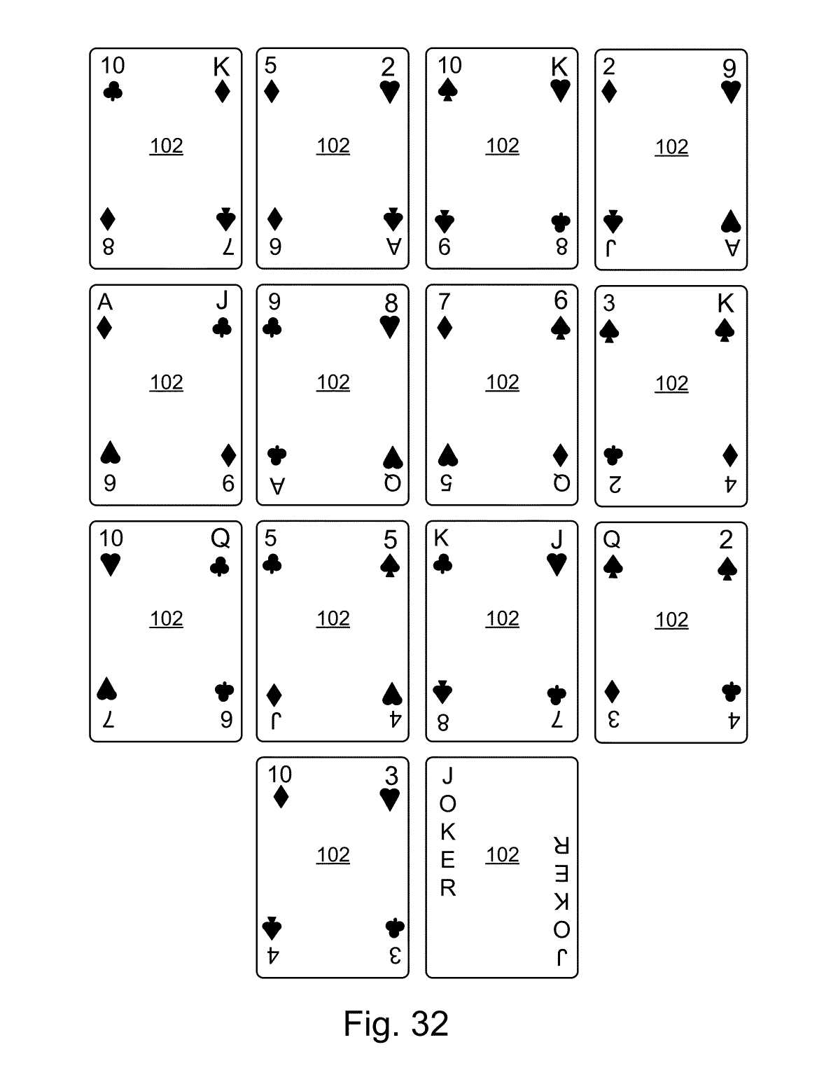

FIG. 23 illustrates a compressed deck of playing cards which has nine cards in the deck, six pips per card, all fifty-two conventional poker deck playing card rank and suit pip symbols, and Joker pips. FIG. 32 illustrates another compressed deck of playing cards, this time with fourteen cards in the deck, four pips per card, all fifty-two conventional poker deck playing card rank and suit pip symbols, and a joker card.

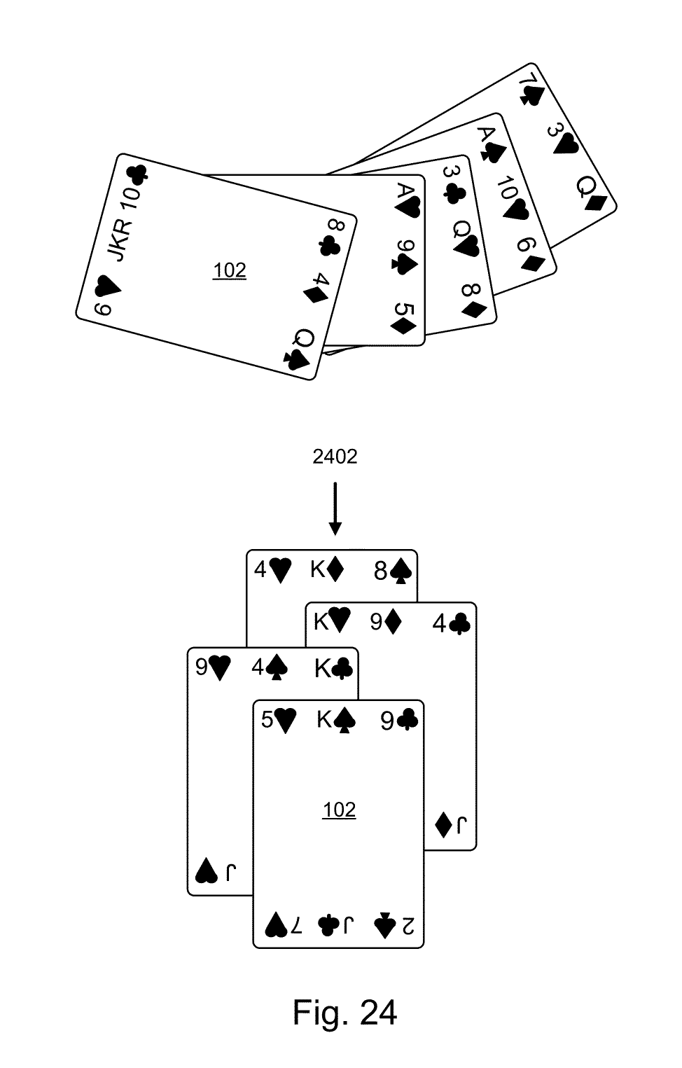

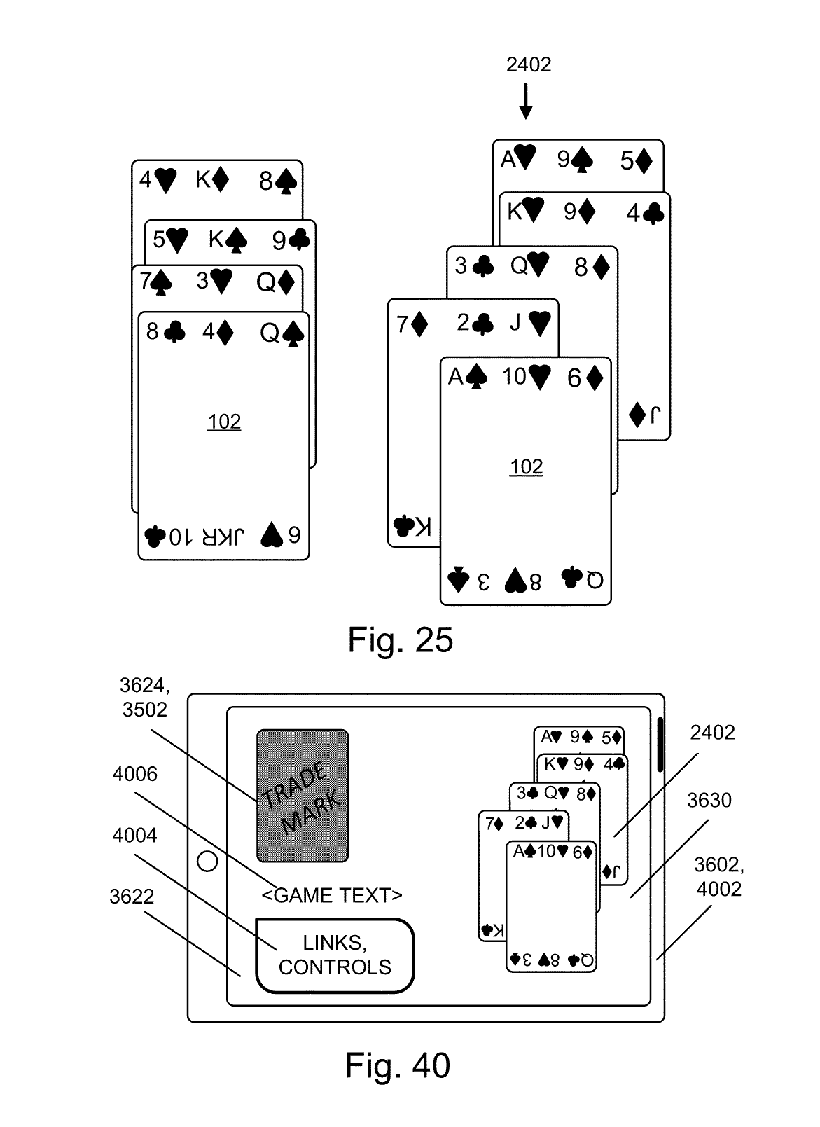

FIG. 24 illustrates a hand 2402 which includes four of a kind in alignment, namely, four kings, drawn from a compressed deck. The deck has nine cards, with six pips per card, all fifty-two conventional poker deck playing card rank and suit pip symbols, and Joker pips. FIG. 25 illustrates a hand 2402 which includes compressed cards aligned in a royal flush in the hearts suit. This hand is from a compressed playing card deck having nine cards in the deck, six pips per card, all fifty-two conventional poker deck playing card rank and suit pip symbols, and Joker pips, but is not necessarily the same deck as in FIG. 24.

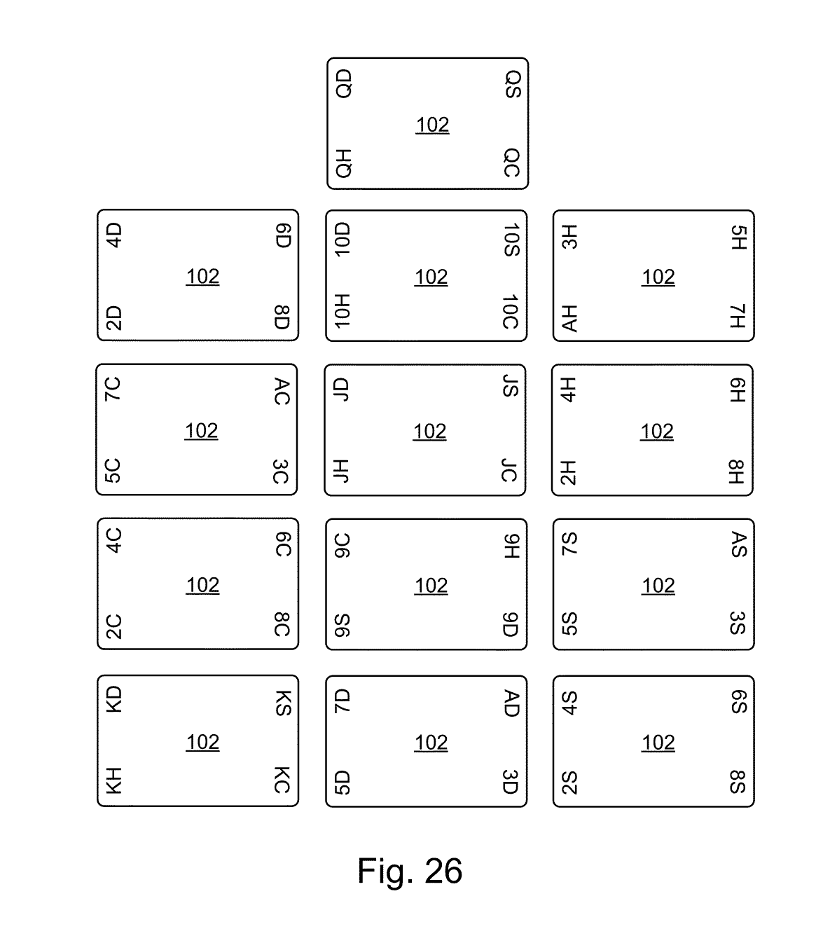

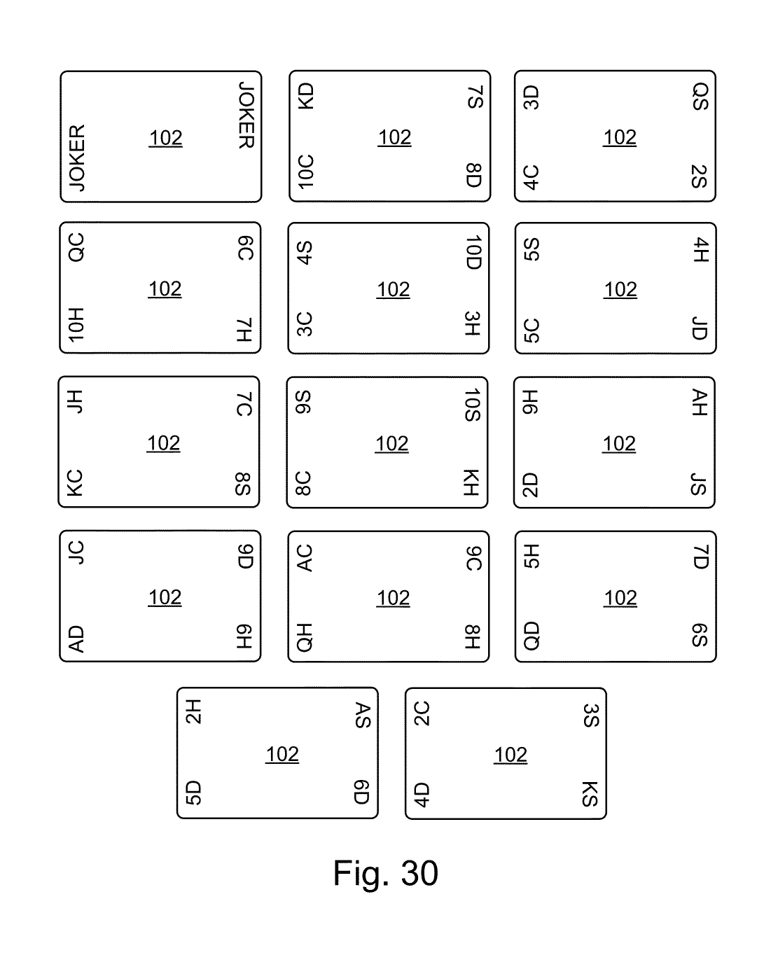

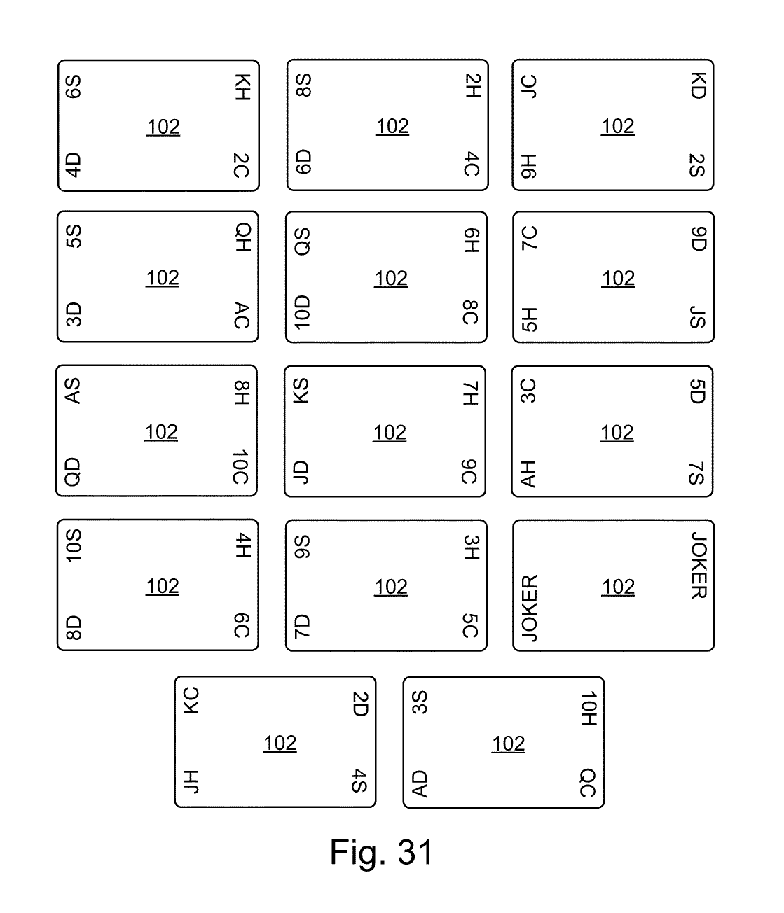

FIG. 26 illustrates a compressed deck of playing cards which has thirteen cards in the deck, four pips per card, and all fifty-two conventional poker deck playing card rank and suit pips. However, the pips are shown in text-only form; H denotes hearts, D denotes diamonds, S denotes spades, C denotes clubs, J denotes jacks, Q denotes queens, K denotes kings, A denotes aces, and numbers denote themselves. Text-only pips are possible in commercial embodiments, but they are particularly useful in prototype decks, because they are faster to draw by hand than pips that contain graphics depicting spades, clubs, hearts, and diamonds. FIG. 27 illustrates another compressed deck of playing cards with thirteen cards in the deck, four pips per card, and all fifty-two conventional poker deck playing card rank and suit pips in text-only form. FIG. 30 illustrates a compressed deck of playing cards which has fourteen cards in the deck, four pips per card, all fifty-two conventional poker deck playing card rank and suit pips in text-only form, and a joker card. FIG. 31 illustrates another compressed deck of playing cards with fourteen cards in the deck, four pips per card, all fifty-two conventional poker deck playing card rank and suit pips in text-only form, and a joker card.

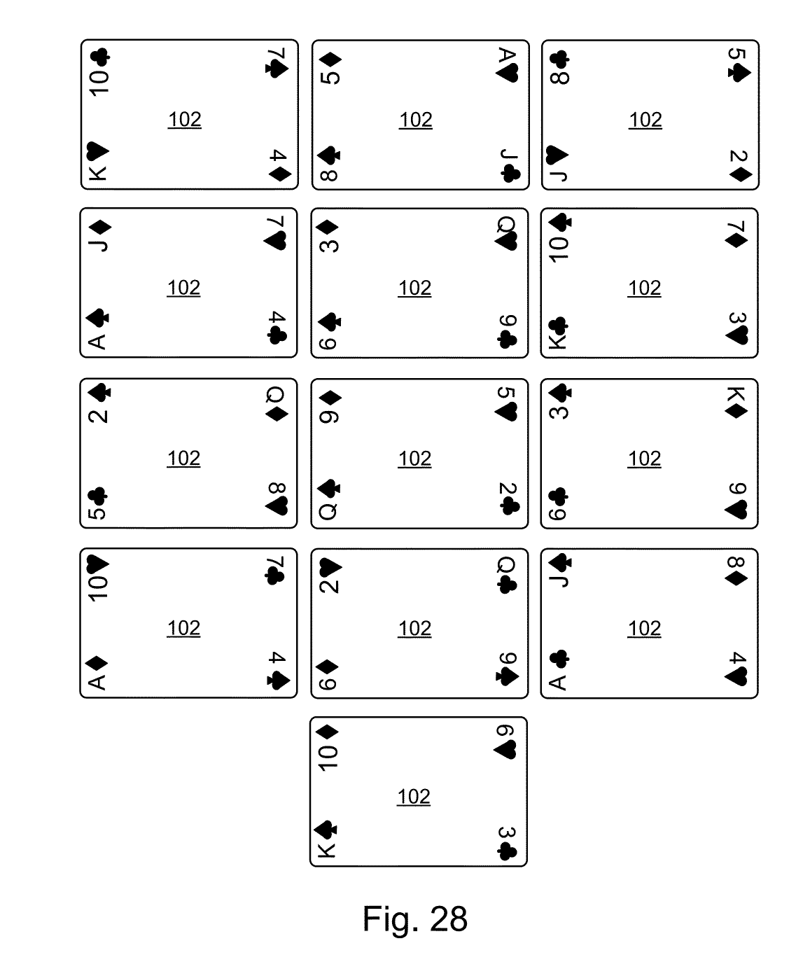

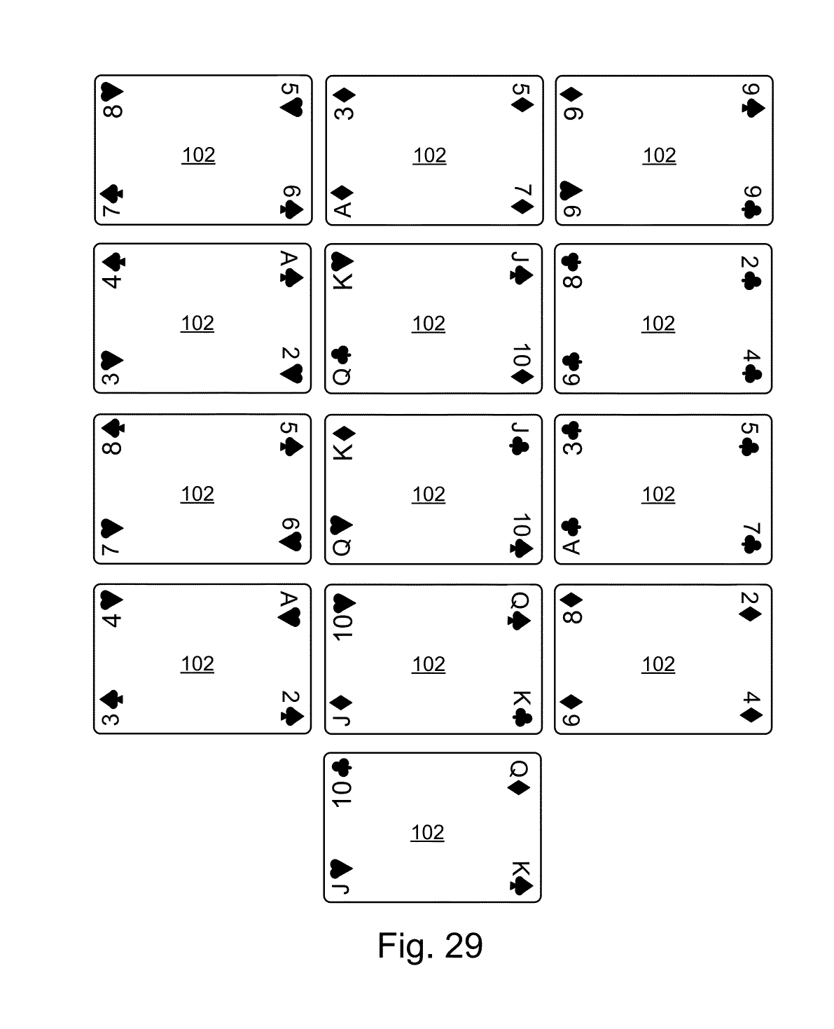

FIG. 28 is a diagram illustrating a compressed deck of playing cards which has thirteen cards in the deck, four pips per card, and all fifty-two conventional poker deck playing card rank and suit pip symbols. In this example, none of the cards bear more than one pip of any given rank or more than one pip of any given suit. By contrast, in the deck illustrated by FIG. 29 some cards have more than one pip of a given rank and/or more than one pip of a given suit.

As a further example of partial or complete pip duplication, consider other decks which are not shown as such but are based on FIGS. 14, 18, and 22. These are decks containing 13 square cards (with rounded corners), 8 pips per card, and two full sets of the fifty-two conventional poker deck playing card rank and suit pips in graphic form. 13×8=2×52=104. In some of these decks, pips are assigned such that the same pip never appears twice on a given card. One such deck is defined as follows:

### Card 1: AH, 2H, 3H, 4H, 5H, 6H, 7H, 8H

### Card 2: 2H, 9H, 10H, JH, QH, KH, AD, 2D

### Card 3: 3H, AD, 3D, 4D, 5D, 6D, 7D, 8D

### Card 4: 4H, 2D, 9D, 10D, JD, QD, KD, AS

### Card 5: 5H, 3D, QD, 2S, 3S, 4S, 5S, 6S

### Card 6: 6H, 4D, KD, 7S, 8S, 9S, 10S, JS

### Card 7: 7H, 5D, AS, 8S, QS, KS, AC, 2C

### Card 8: 8H, 6D, 2S, 9S, 2C, 3C, 4C, 5C

### Card 9: 9H, 7D, 3S, 10S, 3C, 6C, 8C, 9C

### Card 10: 10H, 8D, 4S, JS, 4C, 7C, 10C, JC

### Card 11: JH, 9D, 5S, QS, 5C, 8C, JC, QC

### Card 12: QH, 10D, 6S, KS, 6C, 9C, QC, KC

### Card 13: KH, JD, 7S, AC, 7C, 10C, KC, AH

FIGS. 16 through 33, among others, each explicitly illustrate “multi-pip cards”, namely, cards which bear three or more different pips. Cards bearing only two different pips are not multi-pip herein, although they are compressed, but other features and mechanisms described herein may still apply with two-pip cards, such as card-half-rotation as a move per FIG. 33, pip alignment to form a valuable hand per FIGS. 24 and 25, and/or fitting all pips onto a deck of less than fifty-two cards, per FIGS. 16-33 (a single-suit deck of 13 conventional playing cards does not qualify).

FIG. 34 illustrates two alternatives for placing rank and suit markings relative to each other on a compressed card's face 3402. The card face 3402 on the left shows a side-by-side placement with the rank of the left side of the suit, while the card face 3402 on the right shows an over-under placement with the rank over the suit. Some of the other possibilities not shown include placing the rank on the right side of the suit, placing rank under the suit, and a rank surrounded by the suit. A variation of over-under placement has an imaginary axis through the rank and suit radiating from the card's center, instead of having the axis parallel to a card edge as shown in FIG. 34.

FIG. 35 illustrates two of many alternatives for the back sides 3502 of compressed cards. The card back 3502 on the left shows a trademark over a background and the card back 3502 on the right shows a formalized pattern.

Overlapping Decks

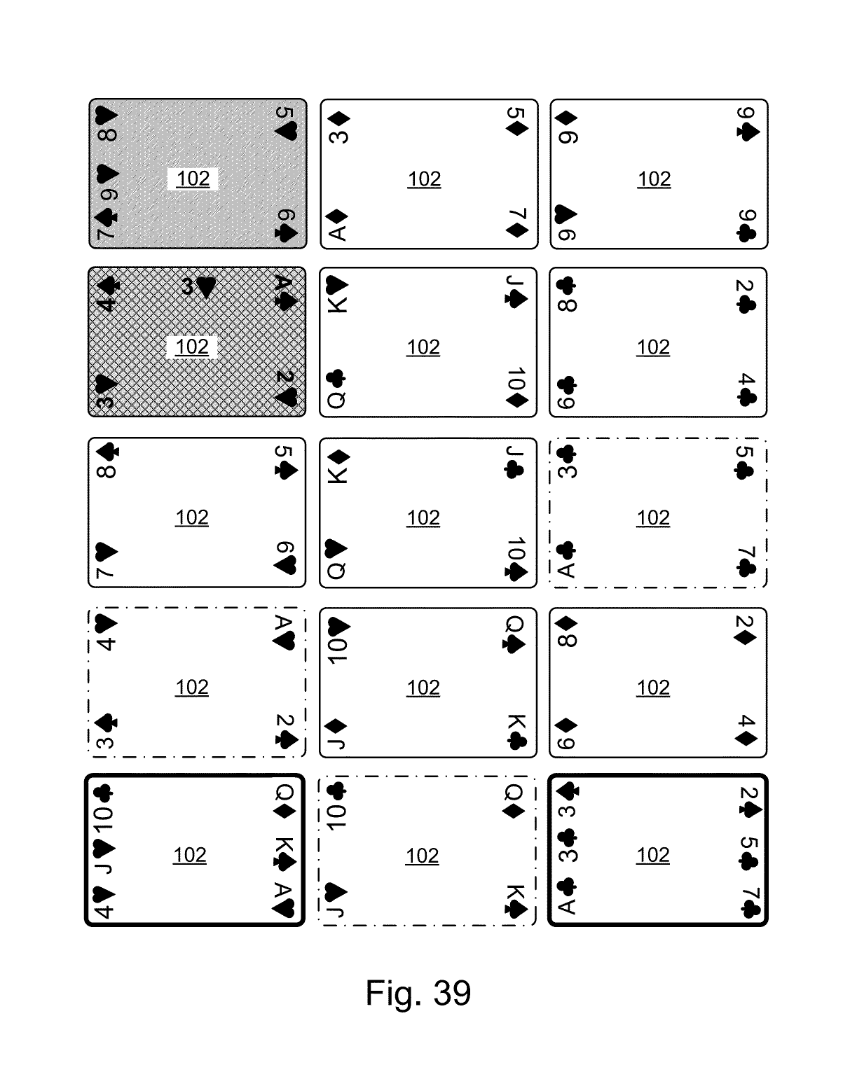

FIG. 39 illustrates two overlapping compressed decks. One deck has thirteen cards, which are indicated in the drawing by all cards except the two in the lower left and right corners which have thickened border lines. Another deck has twelve cards, and is formed by removing three cards from said thirteen-card deck and substituting two cards in their stead. The three removed cards are shown with dashed outlines, and the two cards substituted are the two with thickened border lines. FIG. 39 also illustrates duplicate pips on a given card, namely the card which has a cross-hatched face and two 3 of hearts pips. FIG. 39 also illustrates duplicate pips on separate cards of a given compressed deck, in that the 9 of hearts is on both the card which has a shaded face and the card in the upper right corner of the drawing.

Digital Cards and Decks

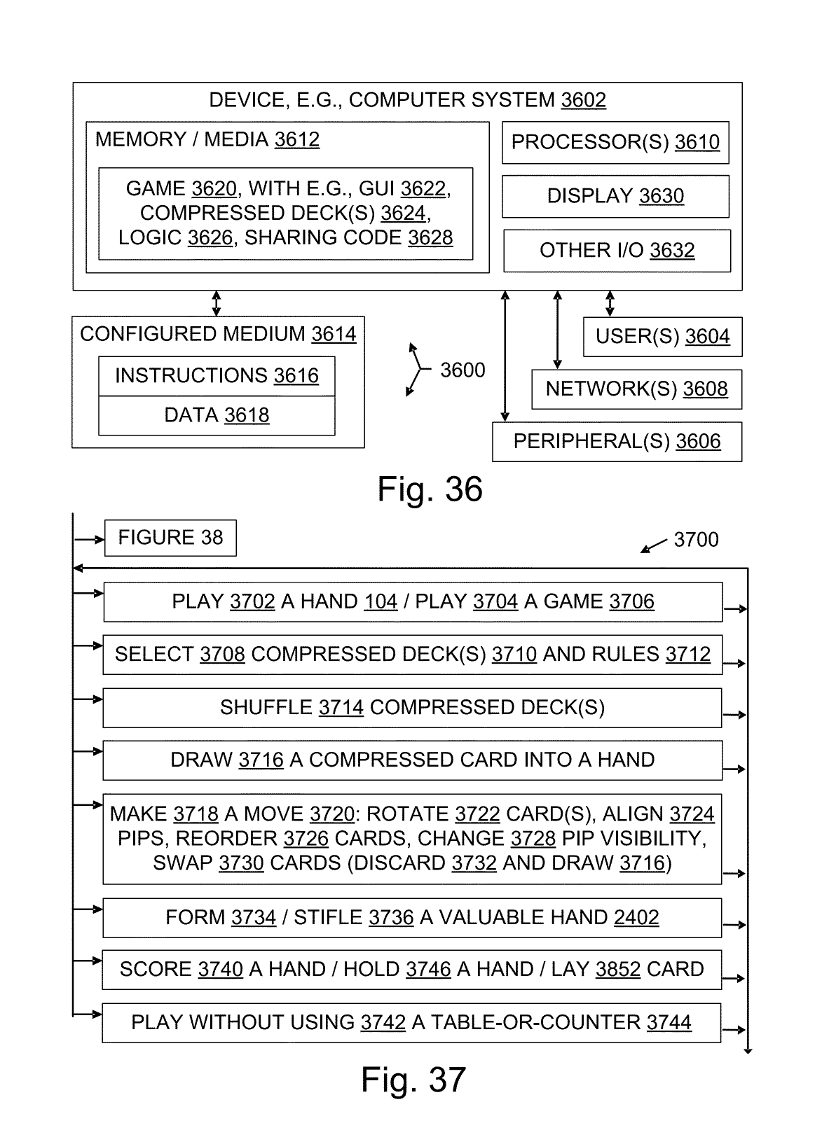

Many embodiments of the innovations and teaching herein will use or include “paper” cards, meaning, cards that work without electricity, made for example of paper or plastic or other materials used for standard playing cards. But some embodiments may use or include digital cards, also referred to as electronic or computerized cards, which do not function without a device that consumes electricity. FIG. 36 illustrates a computer system 3602 having at least one processor 3610 and at least one digital memory 3612 which interact with one another under the control of software for a game 3620 that uses a compressed deck 3624 of cards 102. Other items in an operating environment 3600 may be present on multiple network nodes, as well as configured storage medium 3614 (as opposed to a mere signal) embodiments.

An operating environment for a computer-implemented embodiment may include a computer system or other device 3602. The computer system may be a multiprocessor computer system, or not. An operating environment 3600 may include one or more machines in a given computer system, which may be clustered, client-server networked, and/or peer-to-peer networked. An individual machine is a computer system, and a group of cooperating machines is also a computer system. A given computer system may be configured for end-users, e.g., with applications, configured for administrators, configured as a server, configured as a distributed processing node, and/or configured in other ways.

Human users 3604 may interact with the computer system 3602 by using displays 3630, keyboards, and other peripherals 3606, via typed text, touch, voice, movement, computer vision, gestures, and/or other forms of I/O. A user interface 3622 may support interaction between an embodiment and one or more human users. A user interface may include a command line interface, a graphical user interface (GUI), natural user interface (NUI), voice command interface, and/or other interface presentations. A user interface may be generated on a local desktop computer 3602, or on a smart phone 3602, for example, or it may be generated from a web server and sent to a client 3602. The user interface may be generated as part of a service and it may be integrated with other services, such as social networking services. A given operating environment includes devices and infrastructure which support these different user interface generation options and uses.

Natural user interface (NUI) operation may use speech recognition, touch and stylus recognition, gesture recognition both on screen and adjacent to the screen, air gestures, head and eye tracking, voice and speech, vision, touch, gestures, and/or machine intelligence, for example. Some examples of NUI technologies include touch sensitive displays, voice and speech recognition, intention and goal understanding, motion gesture detection using depth cameras (such as stereoscopic camera systems, infrared camera systems, RGB camera systems and combinations of these), motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (electroencephalograph and related tools).

One of skill will appreciate that the foregoing aspects and other aspects presented herein as part of an operating environment may also form part of a given embodiment. More generally, this document's topic sentences and its headings are not meant to provide a strict classification of features or steps into embodiment and non-embodiment categories.

As another example, a game 3620 may be resident on a game server. The game may be purchased from a console and it may be executed in whole or in part on the server, on the console, or both. Multiple users 3604 may interact with the game using standard controllers, air gestures, voice, or using a companion device 3602 such as a smartphone or a tablet. A given operating environment includes devices and infrastructure which support these different use scenarios.

Players, developers, and administrators are each a particular type of user 3604. Automated agents, scripts, playback software, and the like acting on behalf of one or more people may also be users. Storage devices 3632 and/or networking devices 3632 may be considered peripheral equipment 3606 in some embodiments. Other computer systems may interact in technological ways with the computer system or with another system embodiment using one or more connections to a network via network interface equipment, for example.

The computer system 3602 includes at least one logical processor 3610. The computer system, like other suitable systems, also includes one or more computer-readable storage media. Media 3612 may be of different physical types. The media may be volatile memory, non-volatile memory, fixed in place media, removable media, magnetic media, optical media, solid-state media, and/or of other types of physical durable storage media (as opposed to merely a propagated signal). In particular, a configured medium such as a portable (i.e., external) hard drive, CD, DVD, memory stick, or other removable non-volatile memory medium may become functionally a technological part of the computer system when inserted or otherwise installed, making its content accessible for interaction with and use by processor. The removable configured medium 3614 is an example of a computer-readable storage medium 3612. Some other examples of computer-readable storage media include built-in RAM, ROM, hard disks, and other memory storage devices which are not readily removable by users. For compliance with current United States patent requirements, in the Unites States neither a computer-readable medium nor a computer-readable storage medium nor a computer-readable memory is a signal per se.

The medium 3614, 3612 is configured with instructions 3616 that are executable by a processor; “executable” is used in a broad sense herein to include machine code, interpretable code, bytecode, and/or code that runs on a virtual machine, for example. The medium is also configured with data 3618 which is created, modified, referenced, and/or otherwise used for technical effect by execution of the instructions. The instructions and the data configure the memory or other storage medium in which they reside; when that memory or other computer readable storage medium is a functional part of a given computer system, the instructions and data also configure that computer system.

Although an embodiment may be described as being implemented as software instructions executed by one or more processors in a computing device (e.g., general purpose computer, cell phone, or gaming console), such description is not meant to exhaust all possible embodiments. One of skill will understand that the same or similar functionality can also often be implemented, in whole or in part, directly in hardware logic 3626, to provide the same or similar technical effects. Alternatively, or in addition to software implementation, the technical functionality described herein can be performed, at least in part, by one or more hardware logic components 3626. For example, and without excluding other implementations, an embodiment may include hardware logic components such as Field-Programmable Gate Arrays (FPGAs), Application-Specific Integrated Circuits (ASICs), Application-Specific Standard Products (ASSPs), System-on-a-Chip components (SOCs), Complex Programmable Logic Devices (CPLDs), and similar components. Components of an embodiment may be grouped into interacting functional modules based on their inputs, outputs, and/or their technical effects, for example.

In some environments, one or more original game applications have code whose behavior and/or appearance is modified according to some or all of the compressed playing card changes and enhancements described herein. The code and other items may each reside partially or entirely within one or more hardware media, thereby configuring those media for technical effects which go beyond the “normal” (i.e., least common denominator) interactions inherent in all hardware—software cooperative operation. In addition to processors (CPUs, ALUs, FPUs, and/or GPUs), memory/storage media, display(s), and battery(ies), an operating environment may also include other hardware, such as buses, power supplies, wired and wireless network interface cards, and accelerators, for instance, whose respective operations are described herein to the extent not already apparent to one of skill. CPUs are central processing units, ALUs are arithmetic and logic units, FPUs are floating point processing units, and GPUs are graphical processing units.

Some embodiments provide a computer system with a logical processor 3610 and a memory medium 3612 configured by circuitry, firmware, and/or software to provide technical effects described herein or resulting from compressed play cards or compressed playing card play described herein.

In some embodiments peripherals 3606 such as human user I/O devices (screen, keyboard, mouse, tablet, microphone, speaker, motion sensor, etc.) will be present in operable communication with one or more processors and memory. Software processes may be users.

In some embodiments, the system includes multiple computers connected by a network 3608. Networking interface equipment 3632 can provide access to networks, using components such as a packet-switched network interface card, a wireless transceiver, or a telephone network interface, for example, which may be present in a given computer system. However, an embodiment may also communicate technical data and/or technical instructions through direct memory access, removable nonvolatile media, or other information storage-retrieval and/or transmission approaches, or an embodiment in a computer system may operate without communicating with other computer systems.

Some embodiments operate in a “cloud” computing environment 3600 and/or a “cloud” storage environment in which computing services are not owned but are provided on demand. Some include code 3628 and/or hardware for sharing game play among multiple users 3604, whereas other embodiments are intended for single-player-at-a-time use.

More about Processes

FIGS. 37 and 38 illustrate processes. FIG. 37 is a flow chart illustrating steps of some processes for playing with a compressed deck, while FIG. 38 is a flow chart illustrating steps of some processes for specifying, manufacturing, and/or using a compressed deck. However, any step stated herein is potentially part of a process embodiment. Also, in a given embodiment zero or more stated steps of a process may be repeated, perhaps with different parameters or data to operate on. Steps in an embodiment may also be done in a different order than the order that is stated in examples herein. Steps may be performed serially, in a partially overlapping manner, or fully in parallel. The order in which steps are performed during a process may vary from one performance of the process to another performance of the process. The order may also vary from one process embodiment to another process embodiment. Steps may also be omitted, combined, renamed, regrouped, or otherwise depart from the stated flow, provided that the process performed is operable and conforms to at least one claim of this or a descendant disclosure.

Examples are provided herein to help illustrate aspects of the technology, but the examples given within this document do not describe all possible embodiments. Embodiments are not limited to the specific implementations, arrangements, displays, features, approaches, or scenarios provided herein. A given embodiment may include additional or different technical features, mechanisms, and/or data structures, for instance, and may otherwise depart from the examples provided herein.

Some embodiments include a configured computer-readable storage medium 3612. Medium 3612 may include disks (magnetic, optical, or otherwise), RAM, EEPROMS or other ROMs, and/or other configurable memory, including in particular computer-readable media (as opposed to mere propagated signals). The storage medium 3612 which is configured may be in particular a removable storage medium 3614 such as a CD, DVD, or flash memory. A general-purpose memory, which may be removable or not, and may be volatile or not, can be configured into an embodiment using items such as digital versions of multi-pip cards 102 and code which uses multi-pip card play to modify an original card game, such as poker or other games, in the form of data 3618 and instructions 3616, read from a removable medium and/or another source such as a network connection, to form a configured medium. The configured medium is capable of causing a computer system 3602 to perform technical process steps as disclosed herein. Examples thus help illustrate configured storage media embodiments and process embodiments, as well as system and process embodiments.

As noted in the flowchart 3700 of FIG. 37, some embodiments include playing 3702 one or more hands 104 of compressed cards, while other embodiments include playing 3704 an entire game 3706. In either case, players 3604 select 3708 a compressed deck 3710, either by expressly choosing between multiple decks or else implicitly by choosing a game 3706 that uses a compressed deck. The selection 3708 may be a selection of a compressed deck in lieu of a conventional deck, for instance, or it may be a selection of a particular 13-card compressed deck in lieu of another 13-card compressed deck whose pips are assigned differently, or it may be a selection of a 13-card compressed deck in lieu of a 14-card compressed deck or a 9-card compressed deck, for example. Many choices are possible in view of the teachings herein.

In general, players also select 3708 game rules 3712. Rule selection 3708 includes selection of a game 3706, e.g., card-stack solitaire, poker hand search solitaire, poker, go fish, old maid, twenty-one, thirty-one, and so on. Rule selection 3708 may also include selection of rules specific to compressed decks, such as how many card rotations are permitted to bring pips into play, and modifications of familiar game rules, e.g., a book in go fish is three cards, or the center in hold 'em poker starts with three cards face down, or how many pips per card can be used to make a hand 2402. These and other examples of rules specific to compressed decks are discussed at various locations in this document.

Many games also include shuffling 3714 a compressed deck 3710. Shuffling 3714 involves changing the order of cards, as with conventional shuffling, but in addition shuffling 3714 a compressed deck involves changing the rotational orientation of at least some of the compressed cards. This may be termed “shufflating”, a term coined by the inventor from “shuffling” and “rotating”. As discussed elsewhere herein, and as illustrated for instance in FIG. 33, changing rotational orientation changes the pips available to make a hand 2402. Hence, shuffling attempts to introduce an element of chance into the rotational orientations, as well as (or in some embodiments instead of) attempting to randomize the card order.

Similarly, drawing 3718 a compressed card into a hand 104 involves a not only the pips on the drawn card but also the drawn card's rotational orientation. Accordingly, players 3604 may want to agree ahead of time on how cards are rotated, if at all, when they are being drawn. If a game allows drawing from a discard pile, then player may likewise want to agree on how cards are rotated, if at all, when they are being discarded.

During a game, players make 3718 moves 3720 with their compressed cards and possibly with other game equipment that is also involved in the game. As to the compressed cards, a game may treat any one or more of the following (alone or in combination) as a legal move 3720. One may rotate 3722 a card to change its rotational orientation, e.g., per FIG. 33. One may elect pips by aligning 3724 them, e.g., per FIGS. 24, 25. Note that card edges are not necessarily parallel after alignment; a FIG. 22 top left corner pip might align with another card's top center pip, for example. One may reorder 3726 cards, e.g., so that a card previously in front of another card is moved behind it. One may change 3728 pip visibility, e.g., by reordering, by rotation, or simply by lifting a card up to see which pips are on the card underneath it. One may swap 3730 cards, either with another player, or by discarding 3732 a card and drawing 3716 a replacement for it. Other moves 3720 not shown include betting, bidding, calling, and similar actions from familiar games, possibly adapted for use with compressed decks consistent with the teachings herein.

With regard to the flowchart 3800 in FIG. 38, specifying 3802 a compressed deck can be done, for example, by identifying 3804 the pips to be used on the deck's cards, determining 3805 how many cards will be in the compressed deck, and assigning 3808 the pips to the cards.

Pip identification 3804 may identify pips used in conventional poker decks per FIGS. 11 and 12, for example, or may identify other pips such as color-number combinations (e.g., FIG. 21) or pips used on conventional decks other than American/French poker decks.

Compressed decks are reduced 3820 in card count from conventional decks, but the extent of the reduction varies. Deck card count determination 3805 may include deciding how many pips will appear on each card and then dividing the card count into the number of different pips, e.g., 4 pips per card into a 52-pip collection yields 13 cards, 6 pips per card into the same 52-pip collection yields 9 cards (with room for two joker pips or duplicate pips), 8 pips per card into the same 52-pip collection yields 7 cards (with room for including 3826 four joker pips or duplicate pips), and so on. Calculations may allow room for multiple jokers, or for wildcard pips, or for pip duplication. As another example, one deck includes 8 pips per card, with pip duplication 3822 providing two copies of each of the familiar 52 poker pips, namely, 8 pips per card into 104 pips yielding 13 cards with joker pips 3830 excluded 3828. In this deck, duplicate pips are on different cards than one another, but in other decks a pip is duplicated 3824 on a given card, e.g., the ace of spades might occur twice on an eight-pip card, along with six other pips.

As to manufacturing 3832 compressed card and their decks, cards may be manufactured using suitable adaptations of familiar processes and with materials that are used conventionally to produce playing card stock and print playing cards in conventional decks. In some examples, the cards 102 are formed with stiff paper, card stock, plastic, and/or materials typically used in manufacturing cards used in board games or as conventional playing cards, for example. Game move instructions and other indicia (e.g., brands, graphic designs, and pips) may be printed on the cards using laser printing, ink jet printing, offset printing, lithography, and/or any printing technology typically used in printing playing cards, tarot cards, and/or cards used in board games, for example. Indicia may also be hand-written on cards. The cards may be sized to match or approximate poker cards, bridge cards, playing cards, business cards, tarot cards, mini cards, square 50 mm×50 mm, round, octagonal, or other sizes. Also, cards 102 may be adapted 3834 for use by visually impaired people, through large-print pips, Braille or other tactile notations, and/or oversized cards.

Compressed cards and decks may be implemented 3836 with software, e.g., as an app (application or widget) for a smartphone, a tablet, a laptop, or a workstation, for example. FIG. 40 illustrates a tablet device 4002 configured with cards implemented 3836 digitally with supporting software logic implemented 3838 to support compressed play, e.g., shuffling 3714, making 3718 various moves 3720, and scoring 3740 according to the compressed deck teachings herein. Logic implementation 3838 in this example includes game software controls 4004, menus 4004, and/or links 4004 to other information such as websites, as well as text 4006 displayed by game software, e.g., instructions, scores, and player names. Digital forms of the cards 1-2 are displayed 3848. Digital or physical cards may also be claimed 3850 by a given player during a game, e.g., by placing a token on the card or laying it in a book, for example. Functionality of the app permits players to perform 3840 solitaire play 3842 and/or perform multiplayer play 3844 with other players who are physically present or remote. The app also gets 3846 moves from players for the app to perform.

Although many examples herein use a standard “French” deck with thirteen ranks of four suits as a starting point, other decks can also compressed according to the teachings herein by putting multiple pips on each card, reducing the number of cards, requiring pip alignment to form a valuable hand (which presumes multiple pips along a given edge or otherwise in play for a given card), and/or permitting partial (e.g. half, quarter, or some other fraction) rotation of a compressed card as a move, for example. Some examples of other compressible decks include: Italian playing cards which most commonly consist of a pack of 40 cards (4 suits going 1 to 7 plus 3 face cards); a traditional Spanish deck (baraja espanola); a Swiss deck of 36 playing cards with the suits Roses, Bells, Acorns and Shields; German decks; central European decks 32 or 36 cards; a Russian 36-card deck; and many others.

More About Assigning Pips to Cards

Pip assignment 3808 may be done in many different ways while still fitting 3818 all pips on fewer cards than a conventional deck. Depending on which pips are assigned to which card, the availability of a valuable hand 2402 in a compressed deck will differ from its availability in play with a conventional 52-card one-pip-per card deck.

For example, the top left multi-pip card 102 shown in FIG. 29 has pips 7S, 8H on one end and 5H, 6S on the other. That is, 7 of spades, 8 of hearts on one end, and 5 of hearts, 6 of spades on the other end. Therefore, this deck cannot produce any straights that contain 7S and 8H, because only one of those two pips can be elected during pip alignment. Likewise, this deck cannot produce any straights that contain 5H and 6S, because only one of those two pips can be elected during pip alignment. Moreover, this deck cannot produce any straights or flushes that contain 6S and 7S, because only one of those two pips can be in play at any given time. Similarly, this deck cannot produce any straights or flushes that contain 5H and 8H, because only one of those two pips can be in play at any given time. In addition, this deck cannot produce any hands that contain a pair of nines, or three nines, or four nines, because all four nines are located on the card 102 shown at the top right corner of FIG. 29, and only one of the four pips on a given card can be used in any given hand. In short, in these examples the availability of certain hands 104 has been changed 3812 from what is available with a conventional poker deck.

Pips can be assigned 3808 to cards bearing at least four pips each such that any given hand always produces at least one flush, if three rotations are allowed in order to bring pips into play. To do this, put at least one pip with each suit on each card.

Pips can be assigned 3808 with the goal of preserving 3114 relative hand frequencies, to the extent possible, when comparing the frequencies of valuable hands available in the compressed deck with the frequencies of valuable hands available in the conventional deck.

However, another approach is to favor 3816 certain valuable hands. One embodiment preserves 3810 the availability of all four royal flushes, for example, even though that makes royal flushes considerably more frequent in play with the compressed deck than they are in play with a conventional deck. Specifically, the total number of possible hands in a conventional French deck with no jokers is (52 5), namely 52 items chosen 5 at a time, or (52!/(52−5)! 5!)), using the familiar formula for combinations (n r)=n!/(n−r)!r!. (52 5)=2598960. So the frequency of royal flushes in a conventional deck is 4/2598960=0.00000153907. By contrast, a compressed deck like the one shown in FIG. 19 has 13 cards, each with 4 pips. So the number of available hands is the number of available card selections times the number of hands per card selection. The number of available card selections is (13 5)=(13!/(13−5)! 5!)=1287. Since there are four pips available per card selected, the number of hands per card selection is 4̂5=1024. So the number of available hands is 1287*1024=1317888. Certainly enough to make play interesting, but about half as many as with a conventional deck; 1317888/2598960=0.50708283313. Accordingly, a pip assignment that preserves the availability of all four royal flushes will make royal flushes about twice as frequent in a 13-card deck with the FIG. 19 pip configuration as they are in play with a conventional deck. There are (52 4)=52!/(52−4)! 4!)=270725 such decks; too many to enumerate here but not too many to describe. Similar considerations apply to decks having six pips per card, or eight pips per card, and so on.

Some embodiments assign 3808 pips by hand, using a grid or table such as the following:

| | | |
|---|---|---|
| Card | Top pips | Bottom pips |

| | | | | |
|---|---|---|---|---|
| 1 | AH | 2C | 8D | 2S |
| 2 | AD | KH | 8S | 7H |
| 3 | AS | KD | 8C | 7D |
| 4 | AC | KS | 6H | 7S |
| 5 | QH | KC | 6D | 7C |
| 6 | QD | JH | 6S | 5H |
| 7 | QS | JD | 6C | 5D |
| 8 | QC | JS | 4H | 5S |
| 9 | 10H | JC | 4D | 5C |
| 10 | 10D | 9H | 4S | 3H |
| 11 | 10S | 9D | 4C | 3D |
| 12 | 10C | 9S | 2H | 3S |
| 13 | 8H | 9C | 2D | 3C |

Textual pips are used here for convenience; on the actual cards the pips may be textual or graphical. Other dimensions are used in grids and tables for decks having 6 pips per card, or 8 pips per card, for example. A grid for 6 pips per card has a title row followed by 9 rows representing 9 respective cards, for example.

Some decks are created by first assigning pips for the hand whose availability has the highest priority. For instance, preserving royal flushes means avoiding assigning any card two pips from a given royal flush, since only one pip per card can be used to make a valuable hand. Thus, 10H, JH, QH, KH, and AH must each be on a different card. Likewise, 10D, JD, QD, KD, and AD must each be on a different card, and so on for the other two royal flushes in spades and clubs. As long as there are at least five cards in the compressed deck, this will be possible. Pip assignment can be manual, or it can be automated by software that conforms with and implements the teachings herein.

Next, pips are assigned to preserve the hand whose availability has the next highest priority. This continues, until all pips are assigned.

Some embodiments assign pips to preserve royal flushes and/or straight flushes. Some assign pips with multiple suits per card to reduce the ease with which flushes in general would otherwise be available. With the deck in FIG. 30, for example, allowing at most two rotations means one cannot always make a flush. With the deck in FIG. 28 or the deck in FIG. 31, one can always make a flush. The deck in FIG. 23 makes it easy to create straights. The deck in FIG. 32 makes it easy to get straights, flushes, or full houses, relative to a conventional deck.

Additional Examples of Play

In some embodiments, solitaire play 3842 occurs without using 3742 a table 3744 or a counter 3744 to place cards on. In some cases, play begins by shuffling 3714 a compressed deck of multi-pip cards, altering both their relative order as in conventional shuffling and randomly or arbitrarily or quasi-randomly half-rotating some of the cards. The backs of the cards all have the same pattern, free of pips. The pips are on the cards' faces. The shuffled cards are held 3746 by one's fingers with the backs up (pips hidden). Five cards are drawn. In the draw 3716, rules 3712 may require no half-rotations, or one may alternate half-rotations with non-rotations, or the rules may let the player choose with each card drawn whether to rotate the card wile drawing it, depending on the particular compressed game. The player makes 3718 moves to try and form 3734 the most valuable hand possible within the limited number of moves. Valuable hands can be familiar 5-pip poker hands, or any other familiar pattern of pips, for example.

A move 3720 might be (a) discard and draw a replacement card, or (b) half-rotate a card. Some games count pip alignment as a move; some do not. Some allow a player to arbitrarily reorder the face-up cards without costing a move. Some allow a player to see face-up pips that are not in play; some do not. As to FIG. 16, pips P1 and P2 are in play, while P3 and P4 are not. But as shown in FIG. 33, P1 and P2 could be rotated out of play in order to rotate P3 and P4 into play. Only pips in play can be used to form a valuable hand. One game allows two rotations and one alignment to try and make a valuable hand. Other games allow more or fewer rotations. Some rules 3712 allow draw and discard, others do not.

Because the number of cards in a deck is small, e.g., 14 or less, one can easily hold 3726 the entire deck in one's fingers during play. Thus, the compressed deck can be used for amusement while standing in line, while traveling in cramped quarters, and in many other situations where it is inconvenient or impossible to lay cards of a deck on a flat surface such as a table or countertop during play.

In some examples, each compressed hand also plays quickly, often within a minute or less. So the compressed games can be easily and frequently interrupted with relatively little backtracking or state recovery needed to continue play. Compressed play fits nicely into impromptu and unexpected short periods that would otherwise be wasted, as well as into longer periods of time.

Games with compressed cards can have one or more players, although solitaire and two-player games may turn out to be the most common. Multi-player games can proceed generally as solitaire does, except that players alternate turns/moves. In one version, players are trying to each build their own valuable hand (with one compressed deck each, or with both hands from the same compressed deck, for example). In another version, one player is trying to build 3734 a valuable hand and the other player(s)—with full view of the first player's hand—are trying to stifle 3736 that effort.

Alignment of the pips into a valuable hand is done in some games by moving the pips into a line, as shown for example in FIGS. 24 (aligned kings) and 25 (aligned royal flush in the suit of hearts). In some games alignment is done by moving the cards into one of the configurations shown in FIGS. 1 through 8. This increases the difficulty of achieving a valuable hand, by limiting the pips available to build hands. In some games alignment is the last move, but in others it is the first move.

Testing the multipip compressed deck shown in FIG. 29 against a conventional deck, for example, ten hands per deck, yielded these results:

| Hand | Multipip deck | Conventional deck |
|---|---|---|
| 1 | Straight, S6-S10 | 1 pair, 2 |
| 2 | Flush H (drew it) | 1 pair, 7 |
| 3 | Full house A, 6 | 1 pair, 6 |
| 4 | Full house K, 7 | 1 pair, K |
| 5 | 3 of a kind, Q | 3 of a kind, A |
| 6 | 3 of a kind, 4 | Zip |
| 7 | Straight, S2-S6 | Zip |
| 8 | Flush D | Zip |
| 9 | 2 pair A, J | Zip |
| 10 | Full house 8, K | 1 pair, 2 |

Additional Examples of Compressed Deck Play

One may adapt familiar games by suitably reducing card counts, permitting rotations, and/or electing a subset of available pips per card, for example. One may also form new games using compressed decks.

One example is a “step stack” solitaire game using the 8 pips per card 13 card deck described above; this deck has two copies of each of the 52 familiar pips. The cards are shuffled and held face down in the hands, or place face down on a countertop. A first card is drawn and turned over to form the base of a first stack. In this example, this first card has a 2H pip. A second card is drawn. Under the rules for step stack solitaire, this card can be placed on top of an existing stack if it has a pip which is one step up (one rank higher in the same suit, circular ranking A-2-3-4-5-6-7-8-9-10-J-Q-K-A-2-3-4-5-6-7-8 etc). Otherwise a new stack is started. The goal is to place all cards in a single stack, or alternately, in no more than two stacks. Since the second card has a 3H pip, it is placed on the first card with the 3H pip near the 2H underneath. Then a sequence of cards is drawn, each going on the first stack in this example, namely, 8D on the second card matched by 9D on a third card, JC on the third card matched by a QC on a fourth card, KC on the fourth card matched by an AC on a fifth card, and so on.

Another example game is solitaire “hand hunt” in which a player draws five compressed cards from a shuffled deck and tries to make the best possible poker hand using only a limited number of rotations (a.k.a. twists) to bring pips into alignment to form a valuable hand. For instance, using the same 8 pips per card 13 card deck, one hand drawn was {6D, QC, 2D, KC, AC}. Alignment after zero twists produced a hand with two pair, namely, queens and sevens. However, if one twist is allowed (twist the 2D card) one can align pips to have a full house, queens over sevens.

Another example is compressed deck poker, which may use square or rectangular cards, for instance. Two or more decks of compressed cards can be used in poker or other games. Before the deal, players elect a set of pips to use, such as the top row (P1, P2, P3 in FIGS. 17 and 1; P1, P5 in FIG. 20), left side, sides as opposed to corners (P2, P7, P8, P5 in FIG. 18), or corners as opposed to sides (P1, P3, P4, P6 in FIG. 18), to name some of the possibilities. Sides versus corners is a good choice on decks with eight or more pips per card because there are no opportunities to cheat by rotating a card, unlike top versus bottom on the cards with layouts shown in FIG. 16, 17, 18, 20, or 41. Then play proceeds as in normal poker. Hold 'em can be adapted at least in part by placing only three compressed cards in the center (face down), and going through cycles: deal two compressed cards to each player (2-5 players), place bets, turn up one center card, place bets, turn up a second center card, place bets, turn up the third center card, and then players make the best poker hand they can with their own two cards and the three center cards, using the previously agreed on set of pips, e.g., corners only.

Rummy can also be adapted in part by electing a set of pips to use.

Some game variations allow use of two or more of the pips of a single compressed card when making a hand.

In general, rules for compressed deck play require that the hands also be available in a conventional deck. For instance, {JH, QH, 2H, 5H, JH} is possible with some compressed decks when playing modified poker but it is not an available hand because a conventional deck does not contain two JH cards.

Another example is blackjack (twenty-one) adapted for play with compressed cards. In one game using the 8 pips per card 13 card deck described above, players elected corners and no twists. In another, they elected sides and no twists. Electing or otherwise designating a set of available pips (as opposed to the broader set of visible pips) occurs before cards are dealt in some games, and occurs after some or all cards are dealt, in other games.

Another example is Old Maid. The QH is not removed physically form the deck but is instead “removed” by agreement of the players that it cannot be used. Instead of making pairs as in conventional Old Maid, players make triplets.

Another example is Thirty-one, which is adapted in some examples at least in part by placing only one card in the widow.

Another example is Go Fish, which is adapted by electing sides or corners. Then players ask for “side kings” or “all your side sevens” for example, if sides were elected. A book is made of three compressed cards which have pips of the same rank but different suits, instead of four single-pip conventional cards. In a compressed deck of thirteen cards, for example, the first player to make two books can be declared the winner.

Skwozen® Deck Examples

Skwozen® is a registered mark of John W. Ogilvie for game cards. An embodiment according to some of the teachings herein was publicly disclosed and sold commercially with Mr. Ogilvie's permission under the Skwozen® mark after the filing of the '246 application and the '583 application, and prior to filing of the present non-provisional application. To further illustrate aspects of the present disclosure, information adapted from a Skwozen® product is provided below, with the understanding that (a) the Skwozen® product does not embody every aspect of the present disclosure's embodiments, and (b) the present disclosure includes teachings which are not embodied in the Skwozen® product.

Take the fun of traditional playing cards, add new moves, and then mathemagically squeeze it all down to a very convenient size—that's how we create Skwozen® decks! Each deck is small enough to tuck it and take it, wherever you go. Play Hand Hunt solitaire, Skwozen Poker, Skwozen Blackjack, and other fun games anywhere, even without a table or a countertop. With Skwozen® decks, you really can hold all the cards! To get you started, we've included two Skwozen® decks (one red, one black), along with examples of the new moves that are made possible by these unique patent-pending cards. Also included are quick guides for playing two different Solitaire games, as well as new twists on Blackjack, Poker, Rummy, Old Maid, Go Fish, and Thirty-One. And we bet you'll enjoy Skwozen twists on your other favorite games, too! Card Games Galore in the Palm of Your Hand!

Step Stack Solitaire

1. Shufflate (shuffle and rotate) one deck of Skwozen® cards, place them face down. You can hold the cards in your hands, but this game is easier with a tabletop.

2. Draw a card, place it face up. This is the bottom of your first stack.

3. Draw additional cards and place them in turn, either as the bottom of a new stack or on top of an existing stack. Card B can be placed on card A if B has a “step up”—a pip that is one rank higher and the same suit as a pip on card A. For instance, the 4 of Hearts is a step up from the 3 of Hearts, but the 4 of Diamonds is not.

4. Rotate the placed card to align the pips that show the step up. It's OK if this covers previous steps.

5. You may place a stack Y on top of a stack X as long as there's a step up from the top card of X to the bottom card of Y.

6. Ranking is circular: King above Queen, Ace above King, 2 above Ace, 3 above 2, and so on.

7. Different steps in a stack may use different suits. For instance, a three-card stack could have the first step as 9 of Hearts to 10 of Hearts, and the second step as 2 of Diamonds to 3 of Diamonds.

8. Win the Easy Level by placing the entire deck (14 cards) in three stacks. Win the Regular Level by placing the entire deck in two stacks. Win the Hard Level by placing the entire deck in a single stack.

Hand Hunt (1 to 5 players)

1. Shufflate (shuffle and rotate) one deck of Skwozen® cards for 1 or 2 players, or two decks for 3 to 5 players.

2. Deal each player five cards. Place remaining cards aside.

3. Try to form the best possible poker hand using a limited number of card rotations to align pips. But you may shuffle your cards to change their order as much as you want without rotating them.

4. With two players, set a card rotation limit before the deal. Each player may be allowed zero, or one, or two card rotations. Then deal. After players have seen their hands, shuffled their cards as desired (without rotating them), and done up to the allowed number of card rotations, the player with the best hand wins.

5. In solitaire, set your card rotation limit and set a minimum hand before taking five cards. You win if you form a hand that is at least as good as your minimum hand using no more than the allowed number of rotations. For instance, if your rotation limit is two and your minimum hand is two pair, and you form a straight with only one card rotation, then you've won. But if your minimum hand is a flush and the best you can form with the allowed rotations is two pair, then you lost.

6. Hand ranks are: royal flush, any other straight flush, four of a kind, full house, flush, straight, three of a kind, two pair, one pair.

Skwozen's New Move #1: Pip Choice

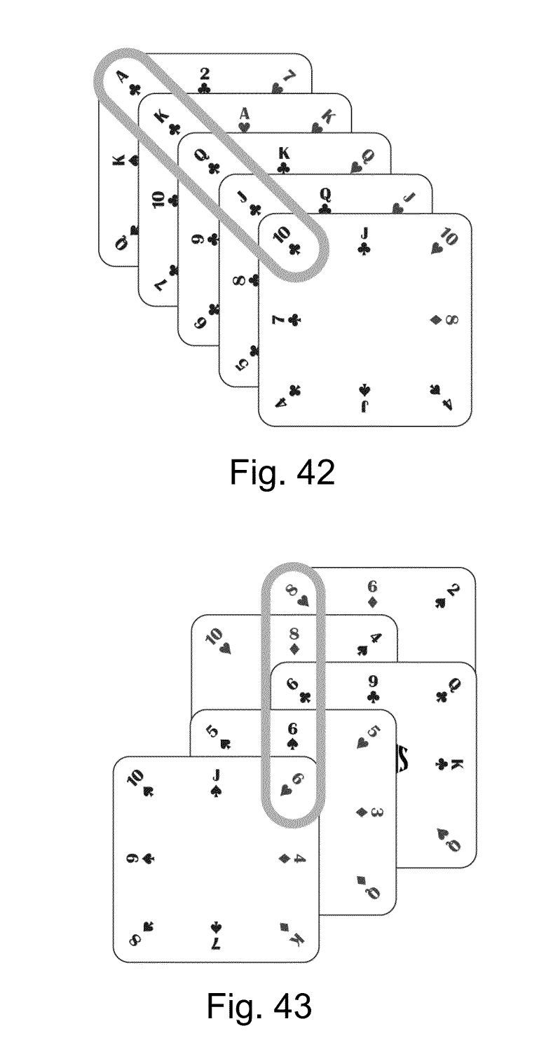

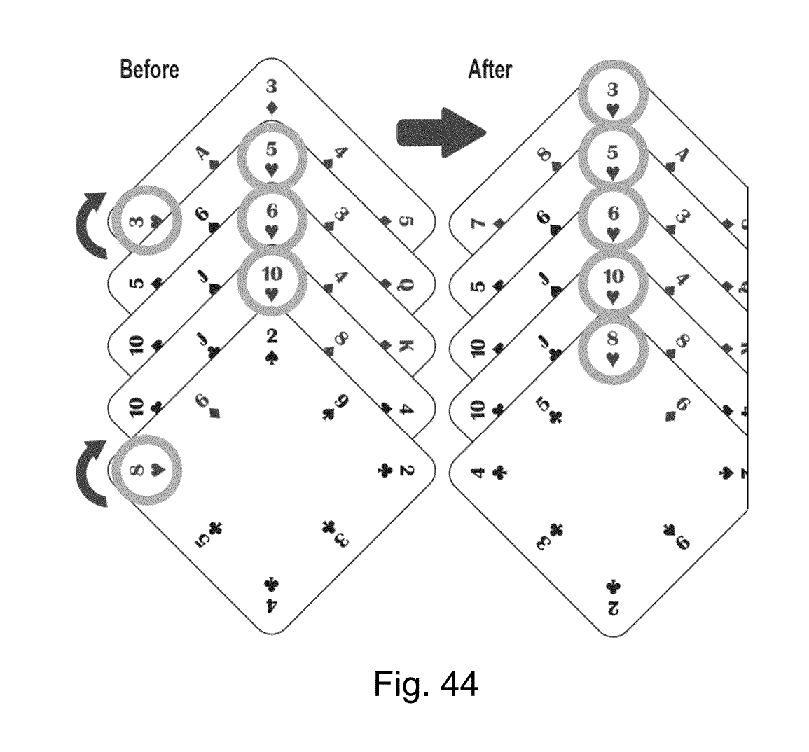

A traditional playing card doesn't give you a choice of pips, because each card has only one pip. Any given traditional card has exactly one rank and one suit. But each Skwozen® card has eight pips to choose from! Choosing between the pips on a card is part of the fun. Sometimes you'll choose a set of pips before you see your cards, while in other games you choose pips after you've seen your cards. You might choose pips by their location, such as “corner pips only” or even “top left corner pips.” You can indicate your pip choices by aligning the pips. For instance, FIG. 42 shows a hand with some corner pips aligned to form a straight. Sometimes you'll choose pips from any location. FIG. 42 shows a hand with pips from various locations aligned to form a full house.

Skwozen's New Move #2: Card Rotation

A traditional playing card doesn't change much when you rotate it, but Skwozen® cards do! After you've chosen one or more pip locations (see New Move #1), rotating a Skwozen card will put different pips in those locations, so you can form different hands. Each quarter-turn of a card counts as one rotation move. For example, you can form a flush with corner pips in two moves, by rotating the top card and the bottom card as illustrated in FIG. 44. The cards' truncation on the right edge of FIG. 44 is an artifact carried over for convenience from the original version of this drawing in the Skwozen® product and has no other significance.

Skwozen Poker

1. Shuffle one deck of Skwozen® cards for 2 players, or two decks for 3 to 5 players.

2. Before the deal, agree on whether to use only the corner pips or only the side (non-corner) pips when forming hands.

3. Players are allowed unlimited rotations and unlimited shuffles of the cards in their hands.

4. Form a hand by aligning pips. When you show your hand, tell the other players which pips you're using to form the hand.

5. For Hold 'em Poker, place three cards in the center face down, deal two cards to each player, place bets, reveal one center card, place bets, reveal a second center card, place bets, and reveal the third center card. Then each player forms the best hand they can with the two cards they were dealt and the three center cards, using the previously agreed on set of pips, e.g., corner pips.

Skwozen Blackjack (21)

1. Shufflate (shuffle and rotate) one or two decks of Skwozen® cards.

2. No card rotations are allowed during play.

3. When a player is dealt their second card, they get to choose which of the eight possible pip locations to use, and their second card is placed on their first card accordingly. Subsequent cards continue to use the same pip location.

4. To show a card's face, the dealer always flips the card so that the bottom edge or edge closest to the dealer becomes the top edge or the edge furthest from the dealer.

5. In a variation, everyone agrees before the deal whether to use only the corner pips or only the side (non-corner) pips when forming hands. When a player is dealt their second card, they choose one of the four (not eight) possible pip locations to use.

6. Standard Blackjack rules apply, except as described above.

Skwozen Old Maid

1. Shufflate (shuffle and rotate) one or two decks of Skwozen® cards.

2. Instead of making pairs of cards as in traditional Old Maid, players try to make triplets, such as three fives, three Jacks, and so on.

3. Cards that have a Queen of Hearts pip remain in the deck, but the Queen of Hearts pips themselves are not used to make triplets.

4. Players are allowed unlimited rotations and unlimited shuffles of the cards in their hands.

5. In the Regular version of this game, any pip on a card can be used in a triplet. In the Advanced version, only corner pips can be used.

6. Standard Old Maid rules apply, except as described above.

Skwozen Go Fish

1. Shufflate (shuffle and rotate) one or two decks of Skwozen® cards.

2. Try to make the most “books” of cards. In Skwozen Go Fish, a book is any three of a kind, such as three tens, three Kings, and so on.

3. Players are allowed unlimited rotations and unlimited shuffles of the cards in their hands.

4. In the Regular version of this game, any pip on a card can be used in a book. In the Advanced version, players agree in advance whether only corner pips or only side (non-corner) pips can be used. Then they ask for cards accordingly, e.g., “Give me all your corner sevens.”

5. Standard Go Fish rules apply, except as described above.

Skwozen Thirty-One

1. Shufflate (shuffle and rotate) two decks of Skwozen® cards.

2. In traditional Thirty-One, the widow has three cards, but in Skwozen Thirty-One it has only one card.

3. Players are allowed unlimited rotations and unlimited shuffles of the cards in their hands.

4. In the Regular version of this game, any pip on a card can be used in a hand. In the Advanced version, players agree in advance whether only corner pips or only side (non-corner) pips can be used.

5. Standard Thirty-One rules apply, except as described above.

Skwozen Rummy (2-6 players)

1. Shufflate (shuffle and rotate) two decks of Skwozen® cards.

2. For 2 players, deal 8 cards each. For 3 or 4 players, deal 5 cards to each. For 5 or 6 players, deal 4 cards each.

3. Players are allowed unlimited rotations and unlimited shuffles of the cards in their hands.

4. In the Regular version of this game, any pip on a card can be used in a set. Sets are three or four of a kind, or a sequence of three or more pips of the same suit. In the Advanced version, players agree in advance whether only corner pips or only side (non-corner) pips can be used in sets.

5. Standard Rummy rules apply, except as described above.

Tile Games

Compressed playing cards on card stock, or another substrate such as cardboard, plastic, wood, or metal, can be used to play various tile games. In general, tile games (also referred to as tile laying games) involve laying the cards on a tabletop or countertop (physical or virtual) so that the pips are placed next to each other in pursuit of a goal pattern and according to specified rules. The goal pattern may be, for example, a group of same-suit pips, or a sequence of consecutively-ranked pips, or consecutive even-ranked pips or odd-ranked pips. The rules may specify, for example, how many cards (namely, tiles) can be laid during a given player's turn, constraints on which previously laid tiles a new tile can (or cannot) be laid next to based on their respective pips, how many laid down tiles may be removed and under what circumstances, whether meeples, coins, or other tokens can be placed or moved or removed from a board which includes or consists of the placed tiles, whether laid tiles can be rotated and under what circumstances and how much, and what points or territory (in the form of laid tiles) are awarded in given circumstances.

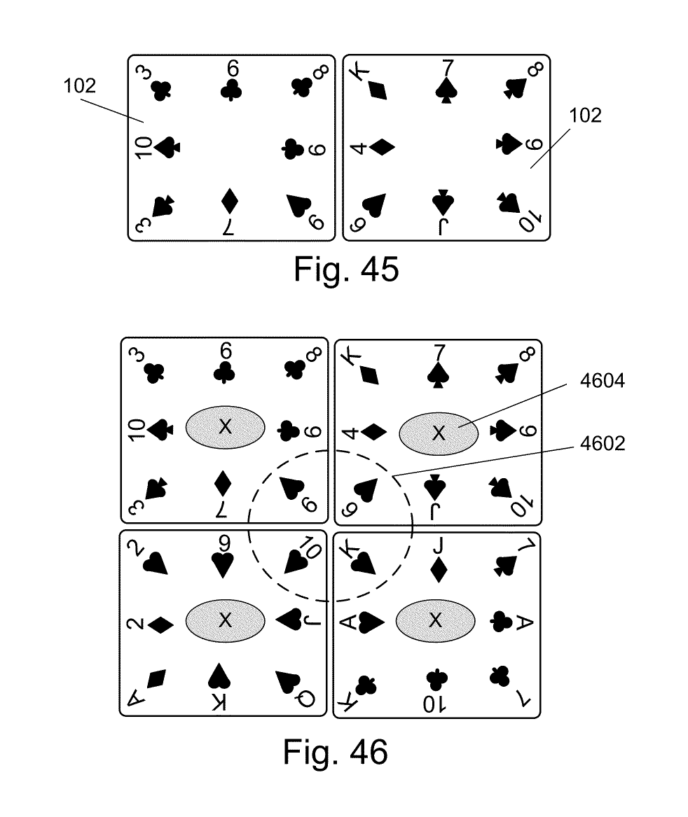

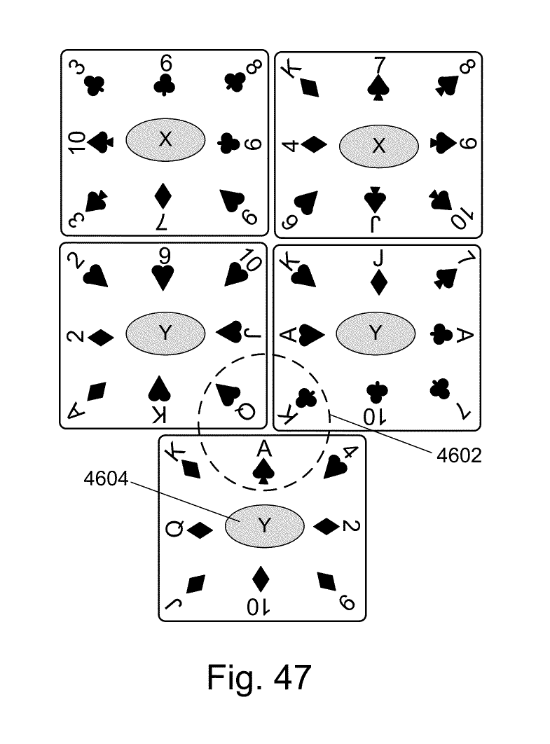

FIGS. 45 through 47 illustrate part of one of the many tile games that can be played according to the present disclosure. As shown in FIG. 45, initially a player Y places (i.e., lays down) 3852 two tiles 102. As shown in FIG. 46, a player X then lays 3852 two more tiles, and as a result forms a core 4602 (cores are also referred to below in an example game as “junctions”). This particular core 4602 conforms with a rule that permits cores in which all adjacent pips have the same suit, which in this example is the suit of hearts. Having created the core, player X is then allowed to claim 3850 the tiles 102 around the new core, which is done by placing a meeple or some other token 4604 on each of the tiles that have a pip in the new core. As shown in FIG. 47, player Y then lays down one card, forming another core 4602, this time using three pips rather than four, and using a sequence of ranks rather than a shared suit. Player Y then claims 3850 the three tiles around this latest core, by placing a Y-owned token on the newly added unoccupied tile and by replacing the X-owned tokens on the other two tiles with y-owned tokens 4604. Play ends when all tiles of a deck have been placed. The player with the most tokens on the board (i.e., on laid tiles) wins. In some versions of such a game, a token can only be removed by being replaced by another player's token. In some versions, placed tiles may be rotated to create a core, in addition to or instead of placing tiles to create a core. Other variations will also be apparent to one of skill in the art given the teachings herein.

As another example, rules and play for one tile game are as follows. Game equipment includes two decks of compressed cards which serve as tiles, and twenty colored tokens for each player, with two to four players recommended. In this example each deck has thirteen square cards (“square” permits rounded corners), eight pips per card, with the 104 pips of a deck including two instances of each of the traditional pips (ace through king, in clubs, spades, hearts, and diamonds), with no jokers.

Shuffle the tiles and place them face down in a draw pile. Turn one tile over and place it on the table as a starter tile. Each player draws three tiles, which they can see but keep hidden from the other players until it is placed on the table. Each player puts all their tokens in their token reserve, e.g., in front of them but not on any of the tiles.

On a player's turn, the player must take two actions if it is possible to do so; otherwise, they take as many actions (one or zero) as they can, and play passes to the next player. Both actions taken in a turn can be the same kind of action if the player so chooses. Allowed actions are (a) draw a tile from the draw pile, (b) place a tile on the table adjacent one or more previously placed tiles, or (c) rotate a previously placed tile. As to (a), there is no upper limit on the number of tiles a player can hold at one time. As to (b), tiles can only be placed such that at the end of the player's turn every junction created by placement of a tile during that turn must be a valid junction; junctions are explained below. As to (c), rotations are not allowed after the draw pile is empty, and all junctions must be valid after a rotation or the rotation is illegal.

In this example with square cards having eight pips each, a junction will include either three or four cards. FIG. 46 shows a junction 4602 of four cards, and FIG. 47 shows a junction 4602 of three cards. A junction is valid if the pips in the junction follow a permitted pattern. In this example, permitted patterns are: (i) all pips have the same suit, (ii) all pips have the same rank, and (iii) the pips are consecutive in rank and have any mixture of suits.

When a player forms a new valid junction by placing one or more tiles, the player takes one or more tokens from their reserve and places a token on top of the center of each tile which did not already have one of that player's tokens on it, thereby claiming the tile. If another player's token was already there, it is removed and returned to the player that owns it. In this example, a player can claim at most as many tiles as they have tokens in their reserve, so the maximum score a player can achieve is the number of tokens they started with in their reserve.

Play continues until all tiles that can be placed have been placed, while respecting the rule that at the end of the player's turn every junction created by placement of a tile during that turn must be a valid junction. The winner is the player with the most tiles claimed (i.e., the most tokens on top of placed tiles).

Some variations alter one or more of the following: the shape of the tiles (e.g., hexagonal or triangular), the number of tiles per deck, the presence of jokers or other wildcard pips, the number of pips per tile, the number of ranks per suit, the number of suits, the names of the suits, the colors and/or symbols which represent each suit, the number of actions per turn (e.g., three instead of two), the maximum number of tiles a player can hold in their hand at a time (e.g., hand limit of three, or of four, instead of no hand limit), the number of tokens per player, whether different players get a different number of actions each turn, the allowable pip patterns for a valid junction, and/or the number of starter tiles (e.g., zero, or two, instead of one), for example.

### Additional Examples

Some embodiments include or use a computer-readable storage medium configured with data and with instructions that when executed by at least one processor causes the processor(s) to perform a process for compressed poker play, the process including the steps of: displaying at least one image of a card bearing at least four different pips (different as to rank, or suit, or both); and displaying an image in which pips of such cards are aligned to form a poker hand and the long edges of at least two cards are not aligned with each other. In some cases, the process further includes rotating at least one such card a fraction of a full circle and redisplaying it in the rotated position.

Some embodiments include or use a deck of compressed playing cards containing less than fifty-two cards yet having at least one graphical or textual instance of each of the fifty-two conventional pips which are represented here textually as AH, 2H, 3H, 4H, 5H, 6H, 7H, 8H, 9H, 10H, JH, QH, KH, AD, 2D, 3D, 4D, 5D, 6D, 7D, 8D, 9D, 10D, JD, QD, KD, AC, 2C, 3C, 4C, 5C, 6C, 7C, 8C, 9C, 10C, JC, QC, KC, AS, 2S, 3S, 4S, 5S, 6S, 7S, 8S, 9S, 10S, JS, QS, KS.

Some embodiments include or use a deck of playing cards having any one or more of the departures from a conventional deck of cards which is discussed herein and/or shown in the Figures, such as for example fewer cards, more pips per card, pips that align to make a valuable hand (1 pair, 2 pair, 3 of a kind, straight, flush, full house, 4 of a kind, straight flush, or royal flush), one or more cards rotated to make a valuable hand, departure from a conventional deck in the relative frequency of valuable hands, departure from a conventional deck in the number of possible valuable hands, use of card rotation and/or pip alignment as moves in modifying a hand or making a valuable hand, adaptations of familiar game rules to use compressed cards.

### CONCLUSION

Although particular embodiments are expressly described herein as processes, as configured media, as articles of manufacture, or as systems, it will be appreciated that discussion of one type of embodiment also generally extends to other embodiment types. For instance, the descriptions of processes also help describe configured media, and help describe the technical effects and operation of systems and manufactures. It does not follow that limitations from one embodiment are necessarily read into another. In particular, processes are not necessarily limited to the data structures and arrangements presented while discussing systems or manufactures such as configured memories.

Reference herein to an embodiment having some feature XX and reference elsewhere herein to an embodiment having some feature YY does not exclude from this disclosure embodiments which have both feature XX and feature YY, unless such exclusion is expressly stated herein. The term “embodiment” is merely used herein as a more convenient form of “process, system, article of manufacture, configured computer readable medium, and/or other example of the teachings herein as applied in a manner consistent with applicable law.” Accordingly, a given “embodiment” may include any combination of features disclosed herein, provided the embodiment is consistent with at least one claim.

Two different reference numerals may be used in reference to a given item in some cases, when one of the numerals designates a particular subset of a broader group that is designated by the other numeral. For example, a first reference numeral may designate services generally while a second reference numeral designates a particular service, or a first reference numeral may designate a category of items while a second reference numeral designates a particular item in that category.

Not every item stated need be present in every embodiment. Although some possibilities are illustrated here by specific examples, embodiments may depart from these examples. For instance, specific technical effects or technical features of an example may be omitted, renamed, grouped differently, repeated, instantiated in hardware and/or software differently, or be a mix of effects or features appearing in two or more of the examples. Functionality shown at one location may also be provided at a different location in some embodiments; one of skill recognizes that functionality modules can be defined in various ways in a given implementation without necessarily omitting desired technical effects from the collection of interacting modules viewed as a whole.

As used herein, terms such as “a” and “the” are inclusive of one or more of the indicated item or step. In particular, in the claims a reference to an item generally means at least one such item is present and a reference to a step means at least one instance of the step is performed. Also, “/” may be used herein as an abbreviation of “and/or”, such that text of the form “x/y” means “x and/or y”.

Headings are for convenience only; information on a given topic may be found outside the section whose heading indicates that topic.

All claims as filed are part of the specification.

While exemplary embodiments have been described above, it will be apparent to those of ordinary skill in the art that numerous modifications can be made without departing from the principles and concepts set forth in the claims, and that such modifications need not encompass an entire abstract concept. Although the subject matter is described in language specific to structural features and/or procedural acts, it is to be understood that the subject matter defined in the appended claims is not necessarily limited to the specific technical features or acts described above the claims. It is not necessary for every means or aspect or technical effect identified in a given definition or example to be present or to be utilized in every embodiment. Rather, the specific features and acts and effects described are disclosed as examples for consideration when implementing the claims.

All changes which fall short of enveloping an entire abstract idea but come within the meaning and range of equivalency of the claims are to be embraced within their scope to the full extent permitted by law.

What is claimed is:

1. An educational and recreational apparatus comprising a deck of cards adapted to form a linear sequence and/or a multi-dimensional tiling and a plurality of individual pips imprinted on the cards at regularly spaced positions, the pips when selectively read in an order according to the linear sequence or multi-dimensional tiling constituting a pattern which includes at least one of the following: a poker hand, a rummy hand, a rummy set, a sequence of consecutive ranks.

2. The apparatus of claim 1, wherein the pips relate to the deck of cards in at least the following ways: the deck of cards supports the pips, each card in a hand formed from the deck of cards has a rotational orientation, and there is a linear sequence of pips with each pip in the pattern residing in a unique position with respect to every other pip in the hand by virtue of the order and the rotational orientation of the cards in the hand, whereby the pips exploit the alterable-sequence nature of the cards.

3. The apparatus of claim 1, wherein the pips relate to the deck of cards in at least the following ways: the deck of cards supports the pips, each card in a set of laid down cards of the deck of cards has a rotational orientation, and there is a multi-dimensional tiling of pips with each pip in the pattern residing in a unique position with respect to every other pip on a laid down card by virtue of the order and the rotational orientation of the laid down cards, whereby the pips exploit the alterable-tiling-arrangement nature of the cards.

4. The apparatus of claim 3, wherein the multi-dimensional tiling of pips includes at least one core consisting of one of the following: pips in a sequence of consecutive ranks, or pips having the same suit.

5. The apparatus of claim 3, further comprising certain tokens belonging to each of at least two players, said tokens each smaller than the size of a face of a laid down card and each capable of being placed on a laid down card to indicate players ownership of points or territory represented by the laid down card.

6. The apparatus of claim 1, wherein each of the cards has at least four different pips.

7. The apparatus of claim 1, wherein each of the cards has at least six different pips.

8. The apparatus of claim 1, wherein the deck of cards contains less than fifty-two cards yet has at least one graphical or textual instance of each of the fifty-two pips which are represented here textually as AH, 2H, 3H, 4H, 5H, 6H, 7H, 8H, 9H, 10H, JH, QH, KH, AD, 2D, 3D, 4D, 5D, 6D, 7D, 8D, 9D, 10D, JD, QD, KD, AC, 2C, 3C, 4C, 5C, 6C, 7C, 8C, 9C, 10C, JC, QC, KC, AS, 2S, 3S, 4S, 5S, 6S, 7S, 8S, 9S, 10S, JS, QS, KS.

9. The apparatus of claim 1, wherein the deck differs from a conventional fifty-two card deck of poker cards in at least two of the following ways: has fewer cards, has more pips per card, has a different relative frequency of valuable hands, or has a different number of possible valuable hands, wherein a valuable hand is any of the following: one pair, two pair, three of a kind, straight, flush, full house, four of a kind, straight flush, or royal flush.

10. The apparatus of claim 1, wherein the deck differs in at least three of the listed ways.

11. An educational and recreational apparatus comprising a deck of cards adapted to form a linear sequence and a plurality of individual pips imprinted on the cards at regularly spaced positions, the pips when selectively read in an order according to the linear sequence constituting a pattern which includes at least one of the following: a poker hand, a rummy hand, a rummy set, a sequence of consecutive ranks, a sequence of consecutive odd ranks, a sequence of consecutive even ranks, a group of multiple pips of the same suit.

12. The apparatus of claim 11, wherein the pips relate to the deck of cards in at least the following ways: the deck of cards supports the pips, each card in a hand formed from the deck of cards has a rotational orientation, and there is a linear sequence of pips with each pip in the pattern residing in a unique position with respect to every other pip in the hand by virtue of the order and the rotational orientation of the cards in the hand, whereby the pips exploit the alterable-sequence nature of the cards and the orientable-rotation nature of the cards.

13. The apparatus of claim 11, wherein each of the cards has at least four different pips.

14. The apparatus of claim 11, wherein each of the cards has at least eight different pips.

15. The apparatus of claim 11, wherein the deck of cards contains less than fifty-two cards yet has at least one graphical or textual instance of each of the fifty-two pips which are represented here textually as AH, 2H, 3H, 4H, 5H, 6H, 7H, 8H, 9H, 10H, JH, QH, KH, AD, 2D, 3D, 4D, 5D, 6D, 7D, 8D, 9D, 10D, JD, QD, KD, AC, 2C, 3C, 4C, 5C, 6C, 7C, 8C, 9C, 10C, JC, QC, KC, AS, 2S, 3S, 4S, 5S, 6S, 7S, 8S, 9S, 10S, JS, QS, KS.

16. The apparatus of claim 11, wherein the deck differs from a conventional fifty-two card deck of poker cards in at least three of the following ways: has fewer cards, has less than twenty cards, has more pips per card, has at least four pips per card, has a different relative frequency of valuable hands, or has a different number of possible valuable hands, wherein a valuable hand is any of the following: one pair, two pair, three of a kind, straight, flush, full house, four of a kind, straight flush, or royal flush.

17. The apparatus of claim 11, wherein the deck differs in at least four of the listed ways.

18. The apparatus of claim 11, wherein each of the cards is square, or is square with the exception of rounded corners.

19. The apparatus of claim 11, wherein each of the cards has a substrate containing card stock.

20. The apparatus of claim 11, further comprising a set of printed instructions for using the apparatus in game play.
